(19) United States
(12) Patent Application Publication
(10) Pub. No.: US 2018/0102625 A1
(43) Pub. Date: Apr. 12, 2018

(54) Theta Laser

(71) Applicant: ECOLE POLYTECHNIQUE FEDERALE DE LAUSANNE (EPFL), Lausanne (CH)

(72) Inventors: Camille-Sophie Brès, Saint-Sulpice (CH); Svyatoslav Kharitonov, Lausanne (CH)

(21) Appl. No.: 15/726,554

(22) Filed: Oct. 6, 2017

Related U.S. Application Data
(60) Provisional application No. 62/405,256, filed on Oct. 7, 2016.

(51) Int. Cl. H01S 3/16; H01S 3/067; H01S 3/108; H01S 3/11

(52) U.S. Cl. CPC H01S 3/1616; H01S 3/0675; H01S 3/108; H01S 3/1608; H01S 3/06791; H01S 3/161; H01S 3/11

(57) ABSTRACT

An unidirectional short-wave infrared fiber laser, comprising a theta cavity, with a gain unit based on rare-earth cations-doped fiber, the theta cavity having a ring cavity with two additional 2 input ports×2 output ports directional couplers DC1 and DC2 inserted therein, one port of the directional coupler DC1 connected to another port of the directional coupler DC2, forming an S-shaped feedback; a band-pass filter to select at a laser wavelength by filtering through transmission inside the theta cavity, the band-pass filter is one of the list comprising a grating-based filter, a Fabry-Perot etalon, and a phase shifted fiber-Bragg grating; and a reflective fiber Bragg grating (FBG) to select the laser wavelength by filtering through reflection inside the theta cavity, the Bragg grating is a notch filter, and the fiber Bragg grating (FBG) is attached to an unused port of the directional coupler DC1 or DC2.

### CROSS-REFERENCE TO RELATED APPLICATIONS

The present patent application claims priority to the United States provisional patent application with the Application Ser. No. 62/405,256, filed on Oct. 7, 2016, the entire contents thereof herewith being incorporated by reference.

### FIELD OF THE INVENTION

The invention relates to a theta cavity laser.

### BACKGROUND

The wavelength region near 2 μm has gained a steadily increasing interest over the recent years. The development of laser sources in this spectral band, based on radiative transitions in thulium and holmium trivalent cations, Tm³⁺ and Ho³⁺ respectively, is motivated by numerous potential applications in spectroscopy, remote sensing, medicine, telecommunications, and material processing. For example, multiple absorption lines of atmospheric components such as H₂O, CO₂ or NO₂ are exploited in differential absorption lidar (DIAL) systems.¹⁻⁴ The first vibration overtone of O—H bond in water has an absorption wavelength of 1.92-1.94 μm, which can be used for laser surgery.⁵ The atmospheric transmission window also includes the 2 μm region, unlocking the way to energy delivery⁶ or free-space communications⁷. Recently, the potential of hollow-core photonic bandgap fibers⁸ (HC-PBGF) combined with thulium doped fiber amplifiers⁹ (TDFA) for fiber optical telecommunication in the 1910-2020 nm band has been reported. Furthermore, the 2 μm spectral range is also widely used to pump holmium doped fibers¹⁰ or to drive nonlinear processes in the mid-infrared (MIR) region.^{11,12} For most of these applications, a broadly tunable narrow linewidth laser source at 2 μm is required.

Due to their many advantages, such as compact size, reliability, and high output power, fiber lasers have shown the most recent developments. Amongst others, the all-fiber core-pumped ring cavity thulium doped fiber lasers (TDFL) exploiting fiberized grating-based filter^{13,14} or Fabry-Pérot etalon¹⁵ as a wavelength selective element, or high power cladding pumped holmium doped fiber lasers¹⁰ were reported. Tunable sources based on parametric conversion and subsequent amplification in thulium doped fibers delivering more than 100 mW of continuous wave power while modulation capable were also recently demonstrated.¹⁶

For fiber ring cavity, an optical isolator should be inserted into the cavity to ensure unidirectional lasing. The fiber isolator conventionally includes Faraday rotators and 45° cross polarizers with adjacent free-space optics,¹⁷ and therefore suppresses backward propagating light within a given bandwidth, generally not exceeding several tens of nm. Therefore, isolator-free unidirectional ring fiber cavity (sometimes referred to “theta”¹⁸ or “yin-yang”¹⁹ resonators) represents an attractive and cost-effective alternative solution. In theta cavities, non-reciprocal losses are introduced by providing an S-shape feedback within the main ring. Ja et al¹⁹⁻²¹ used the fiber theta resonator to implement passive devices such as bandpass/bandstop filters and wavelength division multiplexers/demultiplexer. An erbium doped fiber laser with theta cavity, providing close to 20 dB extinction ratio (ER) between output signals, propagating in favored and suppressed directions, was demonstrated²². Such cavity was also used to realize highly unidirectional ring semiconductor lasers (ER of more than 20 dB),²³ “quantum-dot-in-a-well” lasers (ER of 30 dB),²⁴ and quantum cascade lasers (ER of about 10 dB)²⁵.

Despite all these advancements in the field of theta resonators and 2 μm lasers, still further improvements are desired for theta lasers.

### SUMMARY

According to one aspect of the invention, a unidirectional short-wave infrared fiber laser is provided, comprising a theta cavity, with a gain unit based on rare-earth cations-doped fiber, whereby the theta cavity comprises a ring cavity with two additional 2 input ports×2 output ports directional couplers DC1 and DC2 inserted therein, one port of the directional coupler DC1 being connected to another port of the directional coupler DC2, forming an S-shaped feedback; a band-pass filter configured to select at a laser wavelength by filtering through transmission inside the theta cavity, whereby the band-pass filter in one of the list comprising a grating-based filter, a Fabry-Perot etalon, and a phase shifted fiber-Bragg grating; and a reflective fiber Bragg grating (FBG) configured to select the laser wavelength by filtering through reflection inside the theta cavity, whereby the Bragg grating is a notch filter, whereby the fiber Bragg grating (FBG) is attached to an unused port of the directional coupler DC1 or DC2.

In a preferred embodiment the rare-earth cation-doped fiber is one of the list comprising a thulium-doped silica fiber for emission at 1700-2100 nm, a holmium-doped silica fiber for emission at 2000-2150 nm, thulium-holmium-co-doped silica fibers for emission at 1800-2150 nm, a thulium-doped fluoride fiber for emission at 2200-2500 nm, a holmium-doped fluoride fiber for emission around 3000 nm.

In a further preferred embodiment, the theta cavity with fiber Bragg grating represents a truly all-fiber configuration, without any packaged free-space elements.

In a further preferred embodiment, the rare-earth cation-doped fiber is designed to exhibit the Kerr-nonlinearity coefficient higher than corresponding nonlinear coefficients of a passive fibers in the cavity and thereby including nonlinear amplifying loop mirror (NALM), which consists of cation-doped fiber, and the S-shaped feedback.

In a further preferred embodiment, the fiber laser further comprises a solid-state saturable absorber (SESAM) attached to one of the unused ports of the couplers DC1 or DC2 and configured to achieve a pulsed operation of the theta cavity.

In a further preferred embodiment, the fiber laser comprises an optimized nonlinear amplifying loop mirror (NALM), acting as an artificial saturable absorber, to achieve a pulsed operation of the theta cavity.

In a further preferred embodiment, the fiber laser further comprises a section of dispersion compensating fiber to reduce a duration of generated pulses.

In a further preferred embodiment, the fiber laser further comprises at least one of a polarization controller, and a polarizer in the cavity, thereby achieving an enhanced functionality.

In a further preferred embodiment, the theta cavity with fiber Bragg grating is designed to operate at two different wavelength, by two fiber Bragg gratings attached to free ports of directional couplers DC1 and DC2, or fiber Bragg gratings cascaded at one port, thereby emitting at the same laser transition.

In a further preferred embodiment, the theta cavity with fiber Bragg grating is designed to operate at two different wavelengths, comprising two fiber Bragg gratings attached to free ports of directional couplers DC1 and DC2, or fiber Bragg gratings cascaded at one port, emitting at different laser transitions of a single or dual gain units.

### BRIEF DESCRIPTION OF THE SEVERAL VIEWS OF THE DRAWINGS

The invention will be better understood through the description of preferred embodiments, and in reference to the figures, wherein

FIGS. 1A to 1C show a theta cavity with band-pass filter layout in different scenarios of use A-C;

FIGS. 2A to 2G show a theta cavity with FBG layout in various configurations, with the optical path not affected by FBG in FIGS. 2A to 2C and the optical path influenced by FBG in FIGS. 2D to 2G;

FIGS. 3A and 3B show a Gain Unit (GU) layout and a graph of characterization respectively;

FIGS. 4A to 4C contain illustrations of investigated fiber laser configurations;

FIGS. 5A to 5D contain laser characterizations as a function of operating wavelength and for a pump power of 2 W;

FIGS. 6A to 6C contain graphs showing spectral lines shapes of 2000 nm signals, and the output power stability traces for a pump power of 2 W.

FIGS. 7A to 7C contain lasers characterizations as a function of pump power at 2000 nm operating wavelength;

FIGS. 8A to 8C contain simulated characteristics of theta cavity TDF lasers at 2000 nm operating wavelength;

FIG. 9 shows attenuated emission spectra for different FBGs, with a pump power of 3 W and a 1 nm resolution;

FIG. 10 illustrates laser spectral line shapes for different FBGs, installed in the theta cavity;

FIGS. 11A and 11B illustrate in two graphs laser performance characteristics;

FIGS. 12A to 12E show a series of graphs illustrating theoretical performance characteristics of the theta laser for various combination of the DC1 and DC2 coupling ratios;

FIG. 13 shows theoretical gain coefficient spectra g(λ) and modeled spectral lineshapes S(λ) of the FBG theta laser with (0.9,0.1) coupler split ratio that takes into account phase delays in cavity arms (Eq. (1.12)). The FSR indicates longitudinal modes spacing, Δf_{w}—distance between gain windows;

FIG. 14 shows dual-emission bands theta laser with thulium- and holmium-doped fibers. HDF: holmium-doped fiber;

FIGS. 15A to 15C show single-wavelength laser performance characteristics.

FIG. 15A Output vs. pump power. FIG. 15B Laser linewidth (FWHM) and OSNR vs. pump power. Possible fluctuations of FWHM (linewidth jitter Δσ_{λ}) are shown as well (dotted lines area). FIG. 15C Output laser spectra, recorded at low and high (insets) resolution for various levels of the pump power;

FIGS. 16A to 16C show dual-wavelength laser performance characteristics, with FIG. 16A Output vs. pump power, FIG. 16B Laser linewidth (FWHM) and OSNR vs. pump power, with the dotted lines area depicts the linewidth jitter Δσ_{λ} of 2100 nm laser, FIG. 16C with output laser spectra, recorded at low and high (insets) resolution for various levels of the pump power;

FIGS. 17A to 17D show dual-band theta laser simulations results: coupling rations α and β are alternately swept, and laser performance characteristics are recorded, with FIG. 17A showing 1950 nm emission, generated in GU₁, and coupled into the HDF through DC_{1,2}. FIG. 17B Steady-state gain coefficients, provided by GU₁ and GU₂ at 1950 nm and 2100 nm, respectively, and FIG. 17C Laser output power. D Laser output OSNR. Experimental configuration is labelled with a dashed line. Pump power at 1600 nm is 5.5 W; and

FIGS. 18A to 18F shows a number of theta cavity lasers according to preferred embodiments of the invention.

### DETAILED DESCRIPTION OF PREFERRED EMBODIMENTS

According to some aspects of the present invention, a unidirectional 2 μm thulium doped fiber (TDF) laser is provided, exploiting properties of the theta cavity both with transmission (grating based band-pass filter) and reflective (fiber Bragg grating) wavelength selective elements. The present description will in addition compare the conventional ring cavity design and theta cavities with various feedback values. Experimental results performed with the laser according to the invention validate the potential of TDF theta cavity lasers: they confirm that isolator-free unidirectional TDF lasers are able to provide narrowband emission, which characteristics—power, linewidth, optical signal-to-noise ratio (OSNR)—are competitive, if not superior, with the ones of conventional ring cavities. The TDFL with BPF provides sub-Watt with a slope efficiency of 25%, 2 dB flat tuning range of 1900-2050 nm, and linewidth of 0.2 nm, and achieves the extinction ratio of 18-25 dB between the favored and suppressed lasing directions. Also, we observe some unexpected behaviors tending to indicate that nonlinearity of the thulium doped fiber plays an important role in shaping the theta cavity lasing output. A high power Q-switched theta cavity TDFL using carbon nanotube saturable absorber was also reported by another group²⁶.

Moreover, in a preferred embodiment of the invention, an all-fiber narrow linewidth unidirectional ring TDFL is described, which relies on theta cavity and FBG. The need for a circulator is circumvented by leveraging the already existing architecture. The laser output power reaches 1 W, with 30% slope efficiency and spectral width less than 0.22 nm.

Materials and Methods

Transmission wavelength selective element (band-pass filter).

The fundamental idea behind theta resonators is that of lasing direction rectification by introducing non-reciprocal cavity losses.

In this section, we state a theoretical model that evaluates principal performance characteristics (gain, intracavity and output powers, extinction ratio between directional modes, etc.) of theta cavity lasers. There is no reference representation, published to date, which directly links these parameters to the main cavity features like power split ratios of the couplers, additional losses, amplitude and phase functions of wavelength-tuning elements. Ja et al.¹⁹⁻²¹ proposed a model of a S-shape resonator to implement passive devices such as bandpass/bandstop filters and wavelength division multiplexers/demultiplexers. Similar resonator with an external reflector was considered as a single-pass device, and its spectral selection properties were numerically investigated²⁷. Ring resonator with C-shape feedback and FBG was proposed as well, and an experimental implementation of EDLF, relying on this resonator, was reported²⁸. However, the authors did not analyse the impact of the cavity parameters on the gain unit. Moreover, their claims about the spectral tunability are doubtful, as there is likely a gain competition between an emission peak wavelength and a FBG-selected one.

In the presented model, the amplifying medium (gain unit) is characterized by the single-pass gain function at the wavelength of interest. This function can be either measured experimentally, or evaluated numerically, using the set of coupled rate and propagation equations for the active dopant. We assume a single-wavelength operation, and do not include any gain competition mechanisms, as it requires a quantification of self- and cross-saturation coefficients of the doped fiber amplifier.

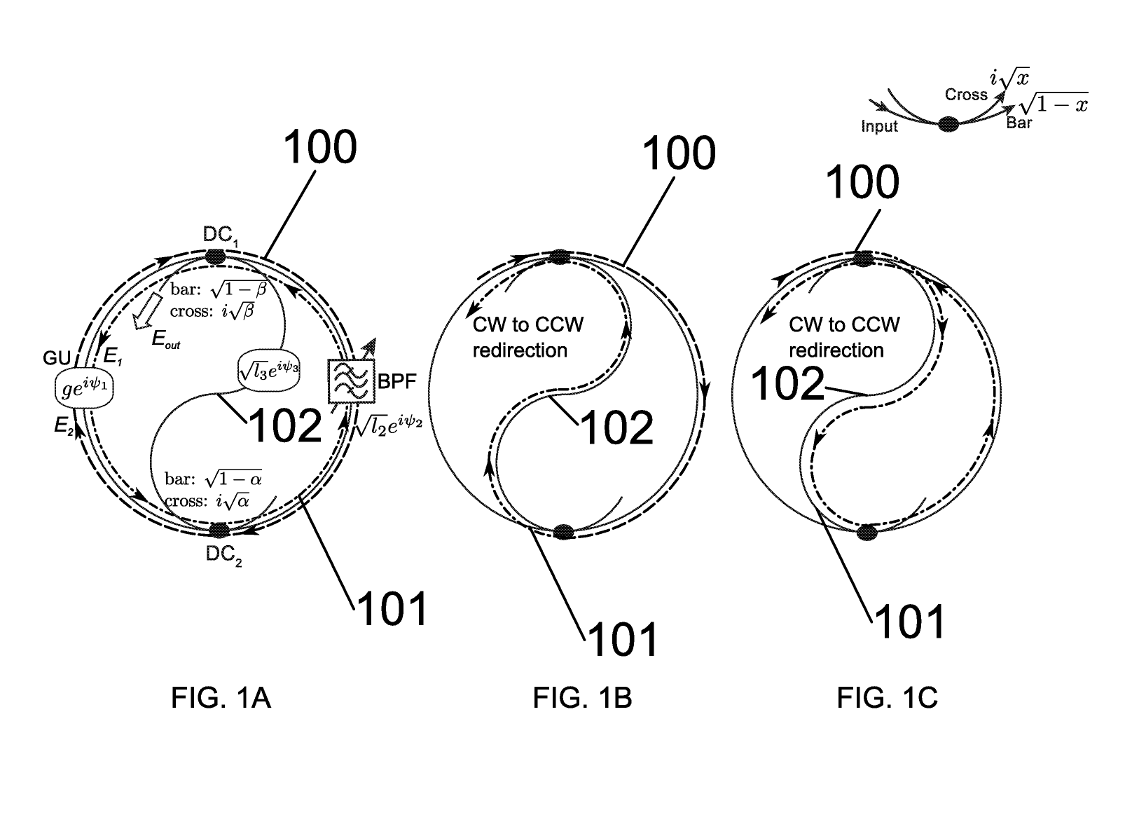

The following model describes such behavior. Referring to FIG. 1, let's consider a generalized ring resonator that consists of a lumped amplifying unit providing a power dependent gain G(P), where P is the input signal powers, and two directional power couplers, which cross-outputs are connected together to provide the S-shape feedback. The power cross-coupling ratios of the couplers DC₁ and DC₂ are denoted as α and β, respectively. The field cross-coupling ratios are i\sqrt{α} and i\sqrt{β}, and the field bar-coupling ratios are \sqrt{1−α} and \sqrt{1−β} for DC₁ and DC₂, respectively. A wavelength selective element (band-pass filter) is inserted in the main ring. The BPF loss is represented by the lumped loss block, l_{2,3} respectively. We define E_{1,n} and E_{2,n} the counter-clockwise 101 (CCW) and clockwise 100 (CW) identical wavelength fields entering the amplifying unit at the n-th round trip, respectively. Finally we consider that the amplified spontaneous emission (ASE) is negligible compared to the signal, when the system reaches steady-state condition.

The time delays due to propagation in the GU, the arm with BPF, and the feedback arm, are introduced by phase terms exp (iψ_{1,2,3}). The output signal can be collected from free port of either of couplers. For example, it could be out-coupled from DC₁.

FIGS. 1A to 1C shows a theta cavity—the ring resonator—with band-pass filter layout, in different scenarios of use in FIGS. 1A to 1C:

FIG. 1A shows main paths for the clockwise propagating modes 100 (CW) and the counter-clockwise propagating modes 101 (CCW), corresponding to a ring;

FIG. 1B shows first possible rectifying path redirecting the CW propagating modes 100 towards the CCW propagating modes 101 through the S-shaped feedback 102: the CW propagating modes 100 go through the bar port of directional coupler 1 (DC₁), the cross port of directional coupler 2 (DC₂) and finally through the cross port of DC₁; and

FIG. 1C shows second possible rectifying path redirecting the CW propagating modes 100 towards the CCW propagating modes 101 through the S-shaped feedback 102: the CW propagating modes 100 go through the cross port of DC₁, the cross port of DC₂ and finally through the bar port of DC₁.

CW propagating modes 100 are plotted with dashed lines, CCW propagating modes 101 are plotted with dashed-dotted lines.

Unlike the CCW propagating signal E_{1,n}, which simply circulates in the cavity (FIG. 1A, a CW signal E_{2,n} gets partially redirected toward the CCW direction by the S-feedback 102, following two possible paths (FIGS. 1B to 1C). Using the known values of the two feedback couplers, we can express at the n^{th}+1 round trip the CCW signal E_{1,n+1} and the CW signal E_{2,n+1} as given by equations 1.1 and 1.2, respectively:

$$\begin{matrix}{{E}_{2 , n} {g}_{2} \sqrt{( 1 - β ) {l}_{2}} i \sqrt{α {l}_{3}} i \sqrt{β} {e}^{i ( {ψ}_{1} + {ψ}_{2} + {ψ}_{3} )} + {E}_{2 , n} {g}_{2} i \sqrt{β {l}_{3}} i \sqrt{α} \sqrt{( 1 - β ) {l}_{2}} {e}^{i ( {ψ}_{1} + {ψ}_{2} + {ψ}_{3} )}}_{CW to CCW redirection} + {{E}_{1 , n} {g}_{1} \sqrt{( 1 - α ) ( 1 - β ) {l}_{2}} {e}^{i ( {ψ}_{1} + {ψ}_{2} )} = {E}_{1 , n + 1}}_{circulation i n the main ring} , & ( 1.1 ) \\ {{E}_{2 , n} {g}_{2} \sqrt{( 1 - α ) ( 1 - β ) {l}_{2}} {e}^{i ( {ψ}_{1} + {ψ}_{2} )} = {E}_{2 , n + 1}}_{circulation i n the main ring} . & ( 1.2 )\end{matrix}$$

In Eqs. (1.1) and (1.2), g_{1,2} stand for the linear gain coefficients provided to the CCW and CW signals, respectively. The CCW signal gets three contributions, represented by the three terms in Eq. (1.1). The first term is the main path contribution, including gain, loss from the cavity and couplers. The second and third terms are the contributions from the re-directed CW light through the first and second feedback paths, respectively. The CW signal only has one term, which represents the contribution from the main path. In the steady-state regime, we can write that E_{1,n+1}=E_{1,n}e^{iφ} and E_{2,n+1}=E_{2,n}e^{iφ}. The coefficient φ stands to the phase, added every round-trip to the laser field. The system of Eqs. (1.1) and (1.2) can be re-written as:

$$\{ \begin{matrix}{E}_{1} [ {g}_{1} \sqrt{( 1 - α ) ( 1 - β ) {l}_{2}} {e}^{i ( {ψ}_{1} + {ψ}_{2} )} - {e}^{i ϕ} ] & + {E}_{2} [ - 2 {g}_{2} \sqrt{α β ( 1 - β ) {l}_{2} {l}_{3}} {e}^{i ( {ψ}_{1} + {ψ}_{2} + {ψ}_{3} ) } ] = 0 \\ & + {E}_{2} [ {g}_{2} \sqrt{( 1 - α ) ( 1 - β ) {l}_{2}} {e}^{i ( {ψ}_{1} + {ψ}_{2} ) } - {e}^{i ϕ} ] = 0\end{matrix} . \qquad ( 1.3 )$$

So, system of equations (1.3) has non-zero solutions, once its determinant is equal to zero. The gain coefficient of the amplifying media should be a real number. Taking into account that the amplifying medium at steady-state lasing regime is typically saturated, which implies that g₁=g₂, we obtain an expression for the gain coefficient:

g\sqrt{(1−α)(1−β)l₂}e^{(iψ}^{₁}^{+ψ}^{₂}⁾−e^{iφ}=0

[symbol]

[symbol]

g=[\sqrt{(1−α)(1−β)l₂}]⁻¹,φ−(ψ₁+ψ₂)=2πm,mϵZ. (14)

Eq. (1.4) represents a common expression for the gain coefficient in a conventional ring laser: the gain is equal to cavity propagation losses (both expressed in dB scale). Moreover, substituting Eq. (1.4) in system (1.3) yields to the condition: E_{2,n}=0, which means that the CW component is completely suppressed for any coupling ratios α and β. The output field Eₒᵤₜ, taking out from the cavity is equal to Eₒᵤₜ=iE₁g\sqrt{(1−α)βl₂}e^{i(ψ}^{₁}^{+ψ}^{₂}⁾ is this case, and the laser output power Pₒᵤₜ=|Eₒᵤₜ|².

Additionally, as will be described in the next section, we experimentally observed that, contrary to the prediction of this simple theory, the value of the coupling ratios influences the ER between favored and suppressed direction. The model also excludes the Kerr nonlinearity, and the backward scattering effects (Rayleigh and Brillouin scattering), which affect the performance of the real laser.

Reflective Wavelength Selective Element (Fiber Bragg Grating)

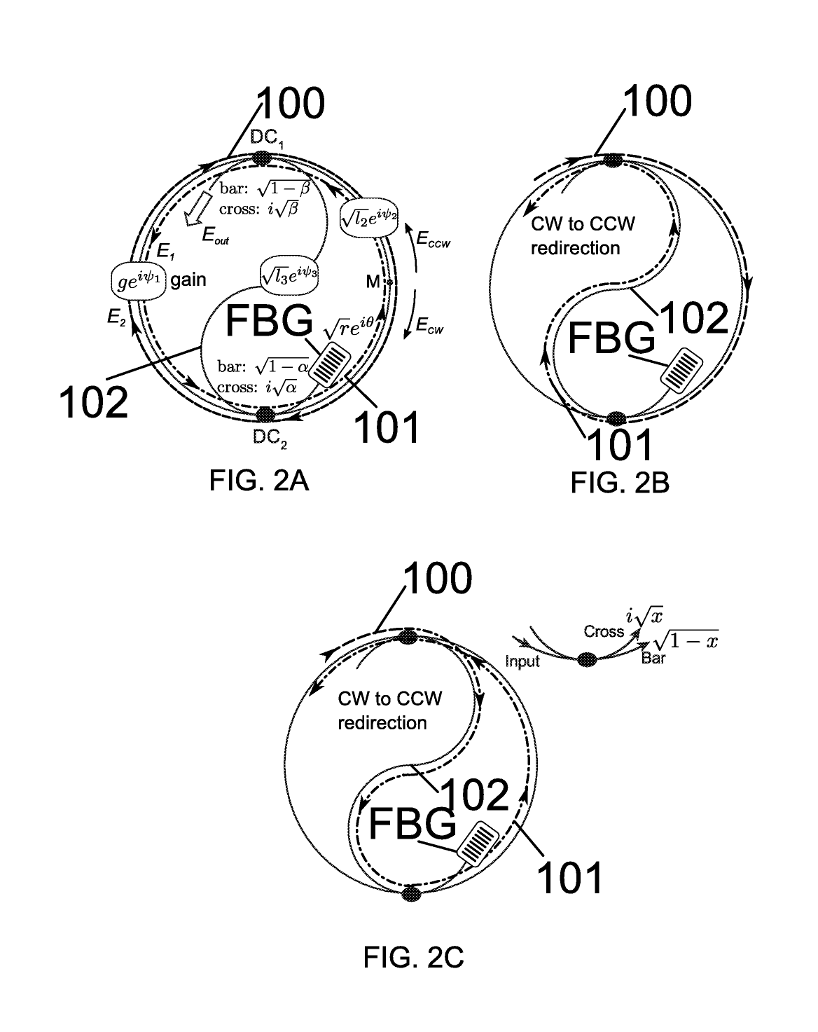

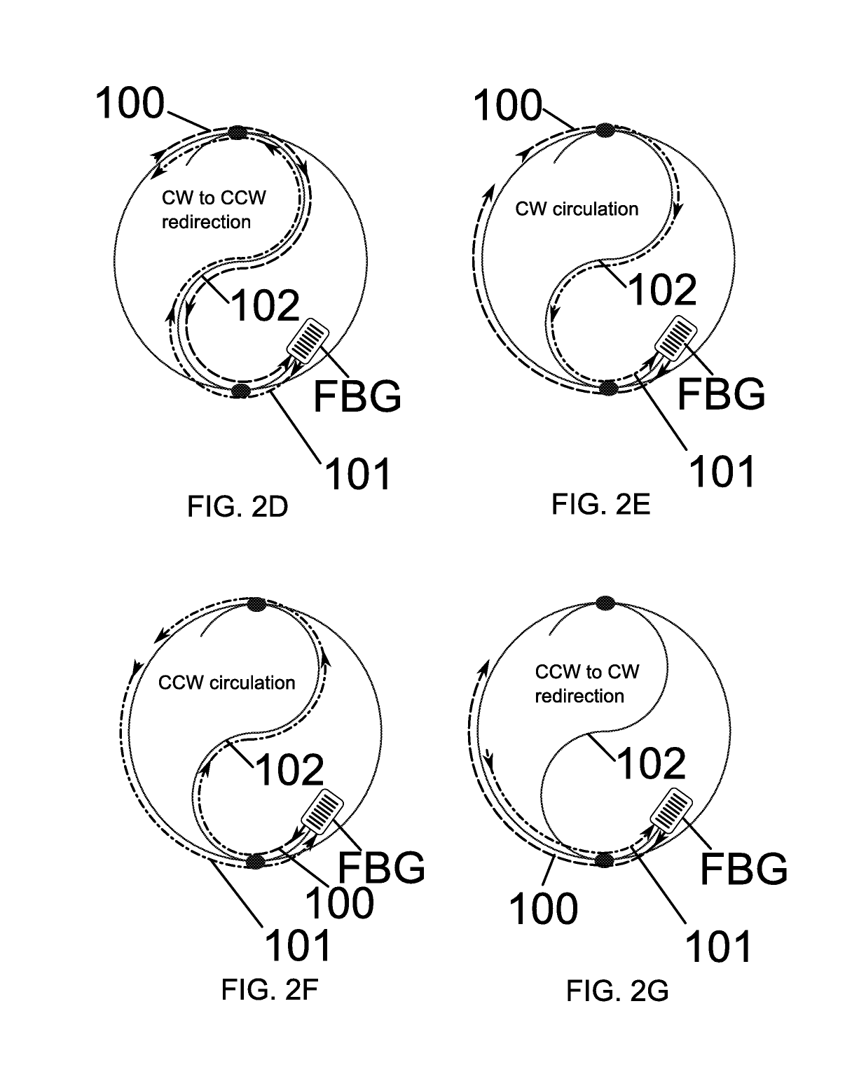

Alternatively, a reflective wavelength-selective element (fiber Bragg grating, FBG) may be attached to one of the unused ports of DC₁ or DC₂ couplers. Thus, one obtains four extra paths, involving the grating: CW to CCW redirection, CW circulation, CCW circulation, and CCW to CW redirection (FIGS. 2D to 2G). Therefore, the laser spectral line shape can be controlled by the FBG in reflection mode, which provides a wavelength selective feedback in the cavity, and that without the need for a circulator or any modification to the original cavity. The FBG transfer function is expressed as \sqrt{r}e^{iθ}, where r—the power reflection coefficient, θ—induced phase shift.

FIGS. 2A to 2G shows a theta cavity with FBG layout in various configurations, with the optical path not affected by FBG in FIGS. 2A-2C and the optical path influenced by FBG in FIGS. 2D-2G.

In FIGS. 2A to 2G, the illustration comprises for when the optical path is not affected by FBG:

FIG. A shows main paths for the clockwise propagating modes 100 (CW) and the counter-clockwise propagating modes 101 (CCW), corresponding to a ring;

FIGS. 2B to 2C show two possible rectifying paths, redirecting the CW propagating modes 100 towards the CCW propagating modes modes 101 through S-shape feedback 102.

The illustration comprises for when the optical path is influenced by FBG:

FIG. 2D shows CW propagating modes 100 to CCW propagating modes modes 101 redirection;

FIG. 2E shows CW propagating modes 100 circulation;

FIG. 2F shows CCW propagating modes 101 circulation; and

FIG. 2G shows CCW propagating modes modes 101 to CW propagating modes 100 redirection.

Applying the same approach, as in the section before, we can derive describe the evolution of E₁ and E₂ fields as following (subscript n, corresponding to the round-trip number is omitted):

$$\begin{matrix}{{E}_{1} g \sqrt{( 1 - α ) ( 1 - β ) {l}_{2}} {e}^{i ( {ψ}_{1} + {ψ}_{2} )}}_{Fig . 2 a} + {{E}_{1} {ge}^{i {ψ}_{1}} i \sqrt{α } \sqrt{r} {e}^{i θ} \sqrt{1 - α} \sqrt{{l}_{3}} {e}^{i {ψ}_{3}} i \sqrt{β}}_{Fig . 2 f} -- {2 {E}_{2} g \sqrt{α β ( 1 - β ) {l}_{2} {l}_{3}} {e}^{i ( {ψ}_{1} + {ψ}_{2} + {ψ}_{3} )}}_{Fig . 2 b \text{-} c} ++ {{E}_{2} {ge}^{i {ψ}_{1}} i \sqrt{β} \sqrt{{l}_{3}} {e}^{i {ψ}_{3}} \sqrt{1 - α} \sqrt{r} {e}^{i θ} \sqrt{{l}_{3}} {e}^{i {ψ}_{3}} \sqrt{1 - α} i \sqrt{β} = {E}_{1} {e}^{i ϕ}}_{Fig . 2 d} , & ( 1.5 ) \\ {{E}_{2} g \sqrt{( 1 - α ) ( 1 - β ) {l}_{2}} {e}^{i ( {ψ}_{1} + {ψ}_{2} )}}_{Fig . 2 a} + {{E}_{2} gi \sqrt{β} \sqrt{{l}_{3}} {e}^{i {ψ}_{3}} \sqrt{1 - α} \sqrt{r} {e}^{i θ} i \sqrt{α}}_{Fig . 2 a} + {{E}_{1} {ge}^{i {ψ}_{1}} i \sqrt{α} \sqrt{r} {e}^{i θ} i \sqrt{α}}_{Fig . 2 g} = {E}_{2} {e}^{i ϕ} . & ( 1.6 )\end{matrix}$$

Simplifying Eqs. (1.5) and (1.6), we obtain a system (1.7), similar to (1.3):

$$\{ \begin{matrix}{C}_{11} {E}_{1} + {C}_{12} {E}_{2} = 0 , \\ {C}_{21} {E}_{1} + {C}_{22} {E}_{2} = 0 ,\end{matrix} \qquad ( 1.7 )$$

with coefficients:

C₁₁=g\sqrt{(1−α)(1−β)l₂}e^{i(ψ}^{₁}^{+ψ}^{₂}⁾−g\sqrt{α(1−α)βl₃r}e^{i(θψ}^{₁}^{+ψ}^{₃}⁾−e^{iφ}, (1.8)

C₁₂=−gβl₃(1−α)\sqrt{r}e^{i(θ+ψ}^{₁}^{+ψ}^{₃}⁾−2g\sqrt{αβ(1−β)l₂l₃}e^{i(ψ}^{₁}^{+ψ}^{₂}^{+ψ}^{₃}⁾, (1.9)

C₂₁=−gα\sqrt{r}e^{i(θ+ψ}^{₄}⁾, (1.10)

C₂₂=g\sqrt{(1−α)(1−β)l₂}e^{i(ψ}^{₁}^{+ψ}^{₂}⁾−g\sqrt{α(1−α)βl₃r}e^{i(θψ}^{₁}^{+ψ}^{₃}⁾−e^{iφ}, (1.11)

By equating its determinant to zero, and solving the resulting quadratic equation, one finds the values g and φ. Roots of this equation are:

$${g}_{\pm } = {p}_{0} \frac{\begin{matrix}\pm \sqrt{α \sqrt{{l}_{3} r} [ 2 {e}^{i ξ} \sqrt{αβ ( 1 - β ) {l}_{2}} + {e}^{2 i ξ} ( 1 - α ) β \sqrt{{l}_{3} r} ]} - \\ \sqrt{( 1 - α ) ( 1 - β ) {l}_{2}} + {e}^{i ξ} \sqrt{α ( 1 - α ) β {l}_{3} r}\end{matrix}}{2 \sqrt{α β ( 1 - β ) {l}_{2} {l}_{3} r} {e}^{i ξ} - ( 1 - α ) ( 1 - β ) {l}_{2}} , \qquad ( 1.12 )$$

where p₀=e^{i(φ-ψ}^{₁}^{-ψ}^{₂}⁾, ξ=θψ₃−ψ₂.

The round-trip phase shift φ is determined from the requirements that ℑ(g_{±})=0 and [symbol] (g_{±})≥0. It results in two possible values of g, and we choose a smaller one, because the laser system tends to converge to the state of a minimal possible gain. In this case the gain profile envelope is evaluated. Additionally, if we would like to locate the longitudinal modes of the cavity, we apply the condition φ=2πm, mϵZ. Therefore, to simplify further the solution, we consider a lossless resonator l_{2,3}=0, and neglect phase shifts of the arms ψ_{1,2,3} for the moment. Thus, the gain coefficient can be presented in the form:

$${g}_{\pm } = {e}^{i ϕ} \frac{\begin{matrix}\pm \sqrt{α \sqrt{r} [ 2 {e}^{i θ} \sqrt{αβ ( 1 - β )} + β \sqrt{r} {e}^{2 i θ} ( 1 - α ) ]} - \\ \sqrt{( β - 1 ) ( α - 1 )} + {e}^{i θ} \sqrt{αβ r ( 1 - α )}\end{matrix}}{2 {e}^{i θ} \sqrt{α β r ( 1 - β )} - ( β - 1 ) ( α - 1 )} . \qquad ( 1.13 )$$

Once g and φ are known, the extinction ratio between E₁ and E₂ fields can be calculated:

$${η}_{12} = \frac{{E}_{1}}{{E}_{2}} = \frac{g \sqrt{( 1 - α ) ( 1 - β )} - g \sqrt{α β r ( 1 - α )} {e}^{i θ} - {e}^{i ϕ}}{g α \sqrt{r} {e}^{i θ}} . \qquad ( 1.14 )$$

(67) Analyzing the Eq. (1.14), we conclude that it is not possible to achieve a perfect rectification (_{E}=0), as η₁₂ is limited for any non-zero finite values of α, r, g. It is expected from the cavity design, where the FBG is attached to a free port of DC₂, so some part of E₁ mode will always be guided to the unfavoured direction.

Finally, having estimations of E₁ and E₂ fields, and the gain coefficient g, the output field Eₒᵤₜ can be calculated as:

Eₒᵤₜ=igE₁[\sqrt{(1−α)β}+\sqrt{(1−α)(1−β)αr}e^{iθ}++η₁₂⁻¹((1−β)\sqrt{α}−β\sqrt{α}+(1−α)\sqrt{(1−β)βr}e^{iθ})]. (1.15)

According to Eq. (1.15), the output power Pₒᵤₜ^{laser}=|Eₒᵤₜ|² of the cavity with FBG depends on both CCW and CW propagating fields, and should be rigorously calculated from known parameters α, β, r, g and φ.

Additionally, we introduce probe fields E_{CCW} and E_{CW}, evaluated at the point M in the cavity (see FIGS. 2A to 2G). These signals can be evaluated during experiment by inserting there an extra coupler:

E_{CW}=E₂g\sqrt{1−β}, (1.16)

E_{CCW}=E₁g\sqrt{1−α}−E₂g\sqrt{αβ}. (1.17)

(71) From Eqs. (1.14), (1.16), (1.17) we derive the expression for the ER between CCW and CW fields, which can be measured experimentally at the probe point M:

$${η}_{CCW / CW} = \frac{{η}_{12} \sqrt{1 - α} - \sqrt{α β}}{\sqrt{1 - β}} . \qquad ( 1.18 )$$

Implementations of the Theta Cavity Lasers

Lasers with a Single Gain Unit

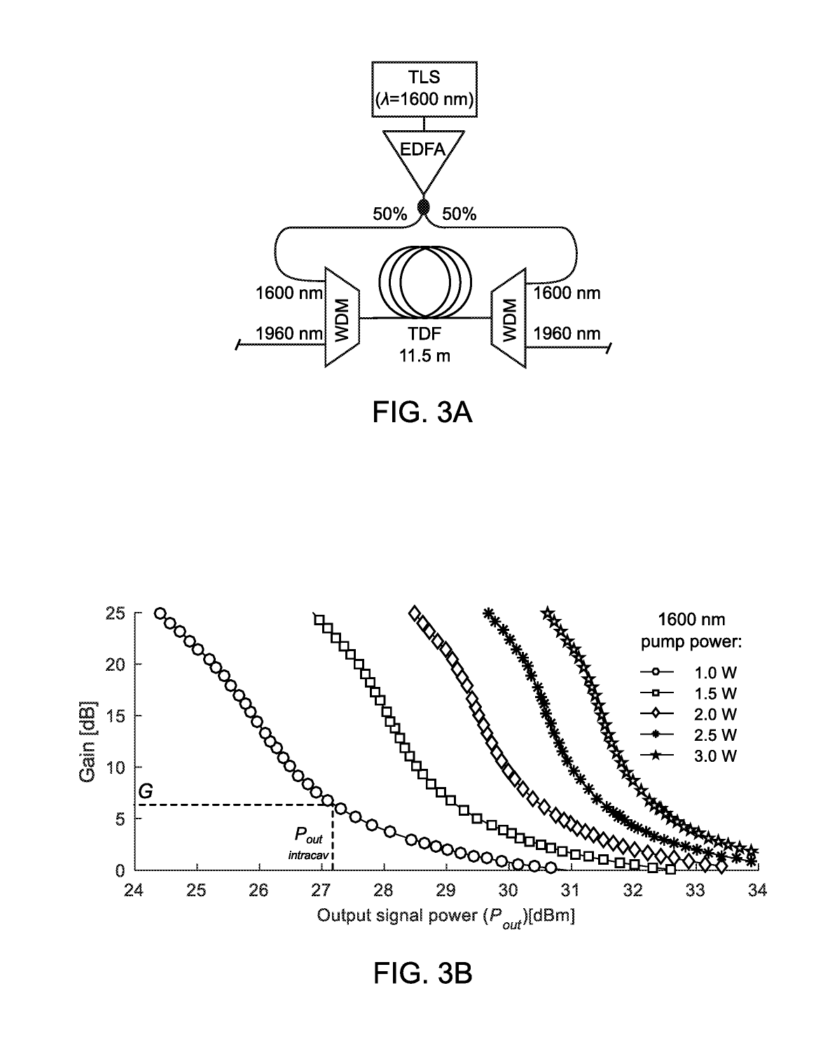

Both the theta fiber cavity and conventional ring fiber cavity based on the same elements were experimentally investigated in order to obtain the first direct comparison between both configurations. The same gain unit (GU) was used for all designs. The GU consists of 11.5 m of thulium doped fiber (TmDF200, OFS Fitel Denmark ApS) bi-directionally core pumped with a 1600 nm pump obtained from an amplified tunable laser source (TLS) as shown in FIG. 3A. It should be noted that the studied GU configuration represents a particular case, and can be modified in all aspects: a single-side pump configuration can be used, the doped fiber length can be varied, another rate-earth cations doping can be applied to achieve the lasing in a different band. The GU was characterized with single-pass power gain measurements (G) as a function of output signal power (P_{OUT}) for a 2000 nm input signal obtained from a customized TDFL. The data were obtained for five pump powers, from 1 W to 3 W, and are plotted in FIG. 3B. Summarizing on FIGS. 3A and 3B, this shows a Gain Unit (GU) layout and a graph of characterization; wherein

FIG. 3A shows a Layout of the gain unit consisting of 11.5 m of thulium doped fiber. Therein TLS is a tunable laser source; EDFA is an erbium doped fiber amplifier; WDM is a wavelength division multiplexer; and TDF is a thulium doped fiber; and

FIG. 3B is a graph containing experimentally measured gain as a function of output signal power Pₒᵤₜ.

To estimate the intra-cavity signal power emitted by the GU in steady-state, the working point, given by G=20 log₁₀|g| is identified on the gain function, where g₀ is a field gain coefficient, evaluated using Eq. (1.4) (the cavity with BPF) or Eq. (1.13) (for the cavity with FBG). The laser output power is then determined using estimated intra-cavity input power, extinction ratio coefficient E₁₂, and cavity parameters.

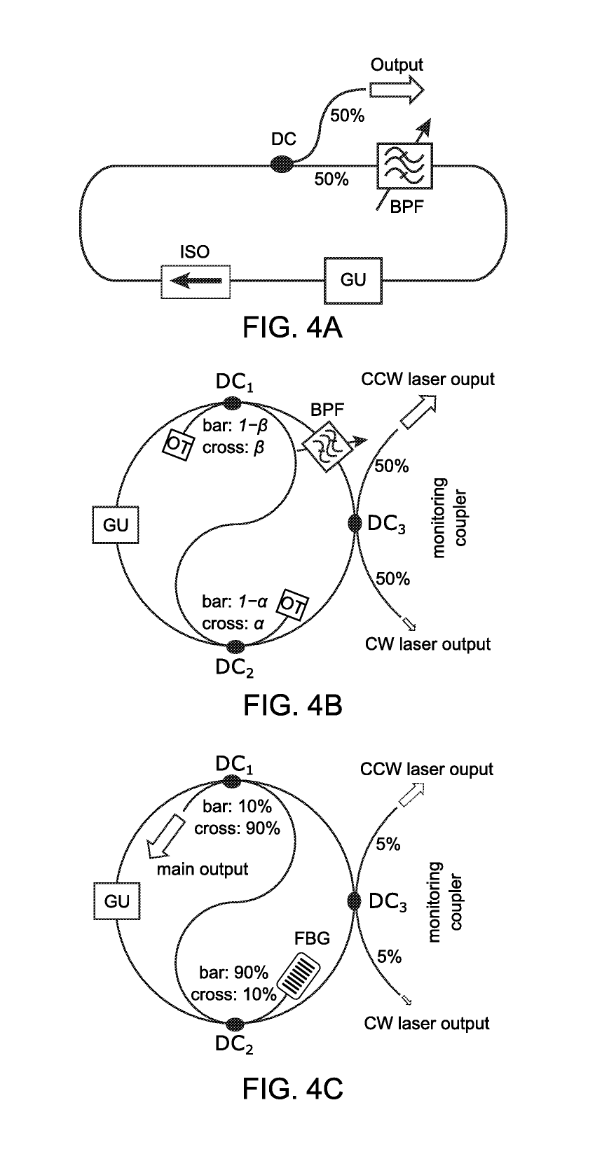

Coming now to FIGS. 4A to 4C, this contains illustrations of investigated fiber laser configurations. The fiber laser configurations in FIGS. 4A to 4C are:

FIG. 4A shows a ring cavity;

FIG. 4B shows a Theta cavity with BPF: the cross coupling ratio of DC₁ may take values β=10%, 50% or 90%. The cross coupling ratio of DC₂ is maintained at α=10%; and

FIG. 4C shows a Theta cavity with FBG: the cross coupling ratio of DC₁ β=90%. The cross coupling ratio of DC₂ is maintained at α=10%. GU: gain unit; BPF: band pass filter; ISO: optical isolator; DC: directional coupler; OT: optical terminator.

A standard ring cavity and the theta cavity with three different feedback values are studied (FIGS. 4A to 4C). In addition to the GU, the ring cavity includes an optical isolator (ISO), a manually tunable grating based BPF (2 nm full width half maximum—FWHM) and a 50% output directional coupler (DC). The theta cavity layout replicates the ring with the exception of the two additional couplers used to replace the isolator in order to introduce non-reciprocal properties, FIGS. 4B to 4C. For theta cavity with BPF, three configurations are investigated by changing the coupling ratio of DC₁: cross-coupling of β=0.1 for configuration Theta1 (i.e. weak feedback), β=0.5 for configuration Theta2 and β=0.9 for configuration Theta3 (i.e. strong feedback). The cross-coupling ratio for DC₂ is held constant to α=0.1 for all configurations. Additionally, in order to prevent any possible parasitic reflections in the cavity, the unconnected ports of DC₁ and DC₂ are terminated (OT) (FIG. 4B). For theta cavity with FBG, the coupling ratios are fixed at 90% and 10% for DC₁ and DC₂ (FIG. 4C). Different FBGs were attached to a free port of DC₂: chirped FBG with central wavelength of 1980 nm, and non-chirped FBGs at 2000, 2008, 2040 nm. The third monitoring 5% coupler (DC₃) is only included to evaluate the ER between CCW and CW modes. To extract the maximum possible power, a free port of DC₁ is used as output.

Results and Discussion

Theta Cavity with BPF

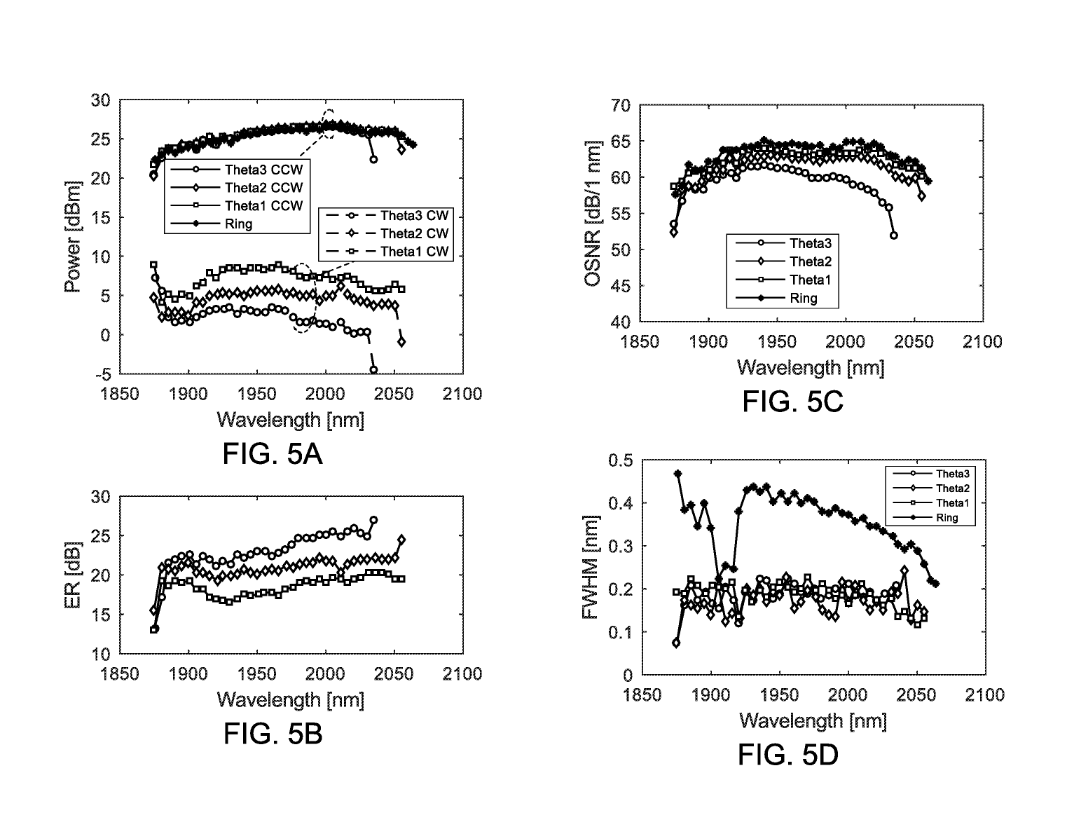

Coming now to FIGS. 5A to 5D, this contains laser characterizations as a function of operating wavelength and for a pump power of 2 W. In FIGS. 5A to 5D, the graphs represent:

FIG. 5A shows output power for the ring cavity and the three theta cavities. Both the favoured laser direction (CCW) and suppressed direction (CW) are shown;

FIG. 5B shows extinction ratio (ER) between the favoured and suppressed directions for the three theta configurations;

FIG. 5C shows optical signal to noise ratio (OSNR); and

FIG. 5D shows linewidth of the lasing wavelength, expressed as full width half maximum (FWHM)

First the output power was measured as a function of wavelength (FIG. 5A).

For the Theta cavities, the results for both the favored direction (CCW in our case) and suppressed direction (CW) are presented and the ER between the two is plotted in FIG. 5B. Contrary to the prediction from the simple theory previously presented, the suppressed direction is not perfectly eliminated, and the extinction ratio changes with the feedback coupling value. As the feedback gets stronger, the CW direction is more efficiently suppressed: an ER in excess of 22 dB is measured for Theta3 while Theta1 has an average ER of 18 dB. Despite these differences, the lasing direction rectification by the introduction of non-reciprocal cavity losses is indeed achieved for different values of feedback. The ER values are in a good agreement with those, reported for theta cavity erbium doped fiber laser. Stable lasing in the range 1900-2050 nm is obtained with the isolator-free cavities. For the 2 W pump, output lasing power in excess of 440 mW is measured for all configurations, with a remarkable 2 dB output flatness, the isolator-free architectures thus showing identical performances to the ring cavity in that regard.

The OSNR for the four lasers, shown in FIG. 5C, is better than 55 dB/1 nm over the entire 1900-2050 nm lasing range, confirming the negligible ASE once the system reaches steady-state. A maximum OSNR close to 62 dB/63 dB between 1950 nm and 2020 nm is obtained for Theta2/Theta1. The overall smaller OSNR of Theta3 is attributed to the higher total cavity losses comparing to the other configurations, which the GU has to compensate for.

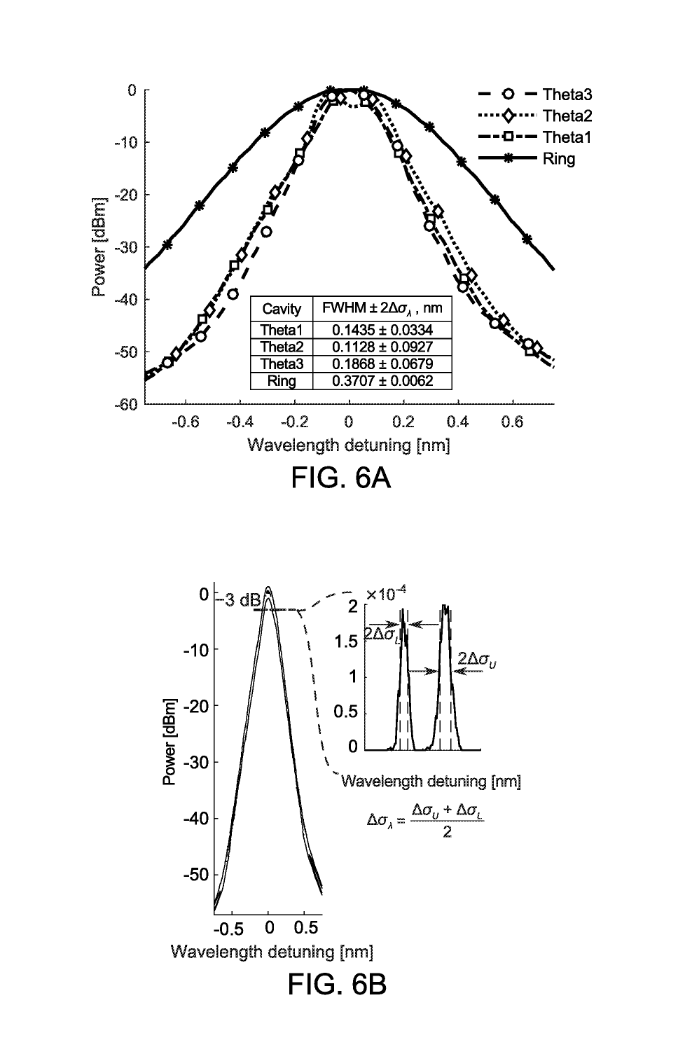

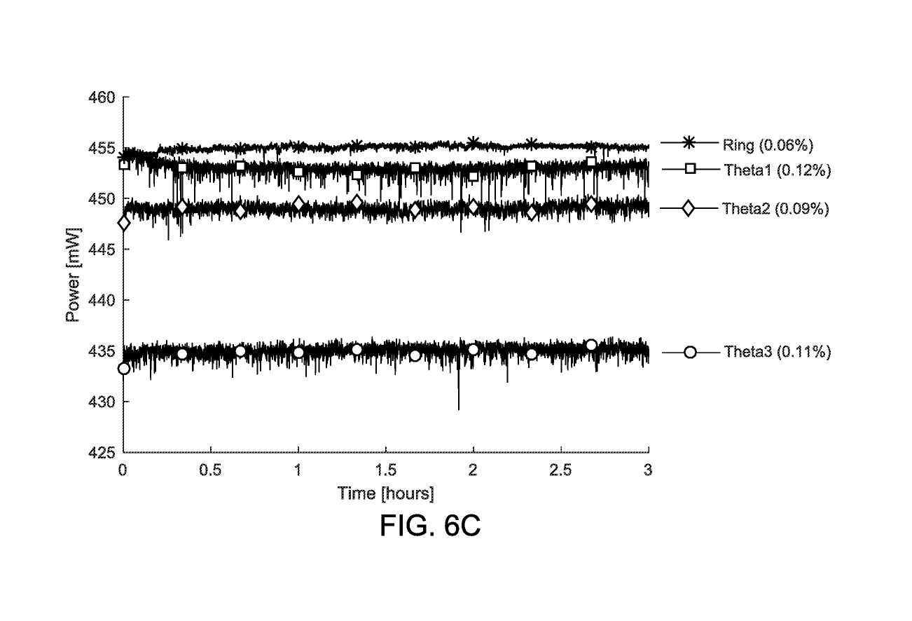

Coming now to FIGS. 6A to 6C, this contains graphs showing spectral lines shapes of 2000 nm signals, and the output power stability traces for a pump power of 2 W. More precisely FIG. 6A to 6C contains:

FIG. 6A shows averaged spectra (over 1000 recordings). Inset table shows width half maximum (FWHM) of the spectral lines and a corresponding wavelength jitter. Spectra are normalized to 0 dBm peak value;

FIG. 6B shows a definition of the wavelength jitter 2Δσ_{λ}. A two-dimensional histogram h(λ,P) is acquired to evaluate 2Δσ_{λ}. The cross section h(λ,−3 dB) generally represents two peaks, and its standard deviations Δσ_{L} and Δσ_{U} are calculated. The overall jitter is determined as 2Δσ_{λ}=Δσ_{L}+Δσ_{U}; and

FIG. 6C shows laser output power, evaluated with powermeter during the stability measurement test. Values in the legend stand for the power standard deviations normalized to the mean powers.

An interesting measure is the linewidth of the lasing light. As the laser line-shape cannot be properly fitted with either Gaussian or Lorentzian functions, the FWHM is determined by 2\sqrt{2 ln 2}σ_{λ}, where σ_{λ} is the standard deviation of the spectral line profiles in the wavelength domain, λ. The spectral line shapes of the four lasers, experimentally obtained for the 2000 nm wavelength are plotted in FIG. 6A. Not only does the shape differ, but the values are significantly different as well. The table in FIG. 6A summarizes the observed FWHM values and indicates the measured wavelength jitter. The procedure for measuring the wavelength jitter is depicted in FIG. 6B: a two dimensional histogram h(λ,P) is acquired to evaluate Ax. The cross section at the −3 dB point, h(λ,−3 dB) generally displays two peaks, which standard deviations Δσ_{L} and Δσ_{U} are calculated. The overall jitter is then determined as 2Δσ_{λ}=Δσ_{L}+Δσ_{U}. We observed that the jitter of the theta cavity laser line at the −3 dB level is higher (30-90 μm) compared to that of the standard ring resonator (6 μm). This might be indicative of a continuous alteration of the longitudinal mode set within the filter bandwidth. This effect is strongly pronounced in the case of Theta2 configuration. The averaged trace clearly possesses two peaks and demonstrates switching between two sets of modes anchored around 2000±0.1 nm. The dynamic can be explained using the following qualitative model: as the re-direction of the CW propagating modes in the theta cavities via the S-feedback is required, the transient time before reaching steady-state as described in Eq. (1.3) can be significantly longer than for a cavity with an isolator. If any environmental fluctuations within this time scale change the mode competition conditions, the transient state in the cavity with another longitudinal mode set could be once again triggered, leading to increasing jitter. During the experiments, no provisions were taken to control operating conditions of the laser. We therefore believe that within a more controlled environment (polarization maintained fibers, temperature stabilization etc.), the jitter could be significantly reduced.

Additionally, several peaks in the laser line (similar to Theta2 emitted spectrum) can be formed by the stimulated Brillouin scattering (SBS), amplified in the doped fiber. The SBS effect in the theta cavity has been already observed and exploited to build the multiple wavelength EDFL²⁹.

The narrower linewidth for all theta cavities is consistent over the entire wavelength lasing range as shown in FIG. 5D. Quantitatively, the laser linewidth is 1.5 to 2 times narrower for the theta resonators, with an average value of 0.2 nm. We also observe that the linewidth remains constant throughout the lasing wavelength region, while the ring cavity exhibits stronger wavelength dependence with values between 0.2 nm and 0.45 nm.

The power of the emitted signals is kept virtually fixed in the stability tests. Its standard deviation normalized to the mean value does not exceed 0.15% during 3 hours (FIG. 6C).

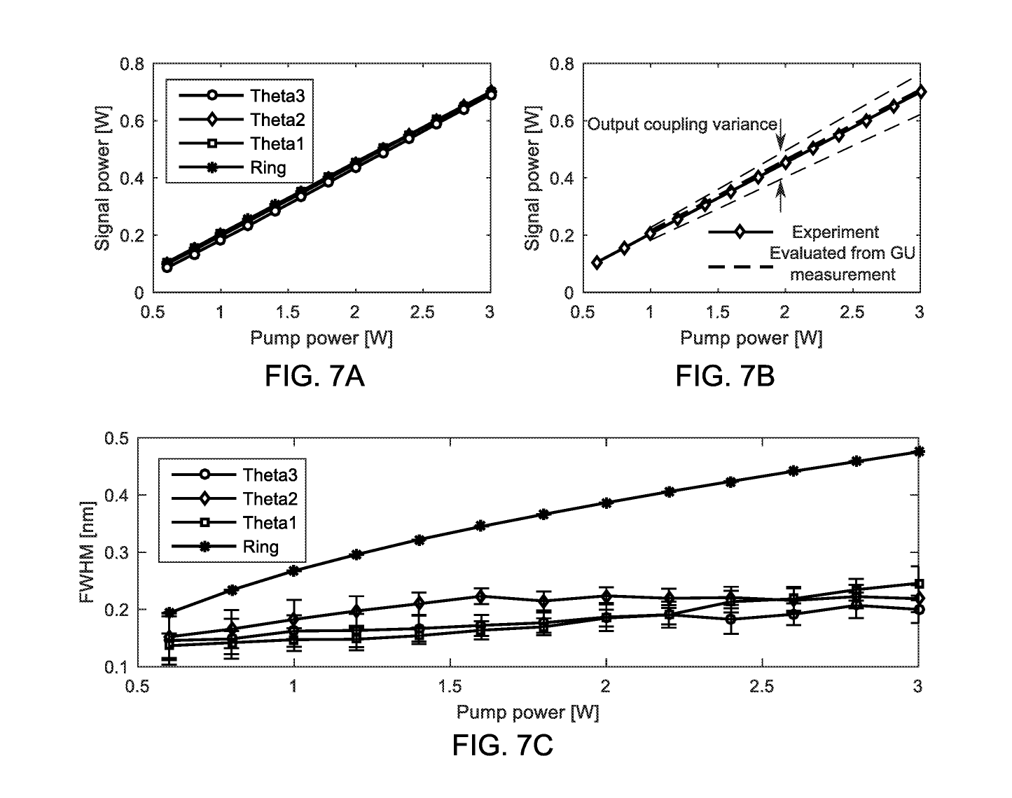

Finally both the output power and linewidth of the 2 μm signal as a function of pump power are measured and the results are shown in FIGS. 7A-7C, respectively.

FIGS. 7A to 7C contains lasers characterizations as a function of pump power at 2000 nm operating wavelength. The parts illustrated in FIGS. 7A to 7C comprise:

FIG. 7A shows signal output power for the four configurations;

FIG. 7B shows a comparison between the measured output power for Theta2 configuration and the values extracted from the gain unit characterization as presented in FIG. 3B. The variance due to imprecision in the cavity losses and output coupling value results in the operating zone as plotted in blue. Only the result for Theta2 is shown for clarity purpose as all other configurations showed similar trends; and

FIG. 7C shows the Full Width Half Maximum (FWHM) of the emitted light. The FWHM of the ring cavity increases with pump wavelength while the ones of the theta cavities are more stable. Overall the theta cavity maintains a narrower linewidth. The standard deviations of the FWHMs are taken into account with error bars.

All four lasers show almost identical results with pump power threshold of about 0.2 W (not shown in the figure) and a slope efficiency in the vicinity of 25%: an output power close to 700 mW can thus be obtained when pumping with 3 W. This slope efficiency is a very close to the value of 26%, reported for conventional all-fiber ring TDFL¹³. The experimental data for the output power is compared to the evaluated values using the measurements of the GU (FIG. 3B) and losses. For readability, only the result for Theta2 is shown in FIG. 7B as all lasers showed similar trend. Overall a good agreement is reached, the measured powers falling on the upper limit of the operating zone as the setup was fully optimized to reach the highest output powers. Finally, to our opinion the most remarkable feature of the theta cavity can be observed in FIG. 7C. Contrary to the ring cavity, which exhibits an increased laser linewidth with pumping power, the linewidth of theta cavities lasing wavelength remains mostly constant.

In order to gain further understanding on thulium doped theta cavity laser, we performed simulations of such configuration. The simulation platform allows us to include the Kerr nonlinearity of the gain medium, an important parameter that is omitted in the simplified analytical description. Indeed, we have experimentally evaluated a nonlinear coefficient of TmDF200 fiber as high as 3.6-4.1 W⁻¹ km⁻¹. The impact of γ on the performance of ring/theta cavity lasers is therefore investigated numerically by implementing the experimental configurations shown in FIG. 4b using VPItransmision Maker software (VPI). The TDF model, implemented in VPI, is based on the solving of the coupled rate equations for the population inversions of ³H₆, ³F₄, ³H₄, and ¹G₄ energy levels and propagation equations for the signals and ASE components.³⁰⁻³³ The only effect of self-phase modulation (SPM) is included into the model.

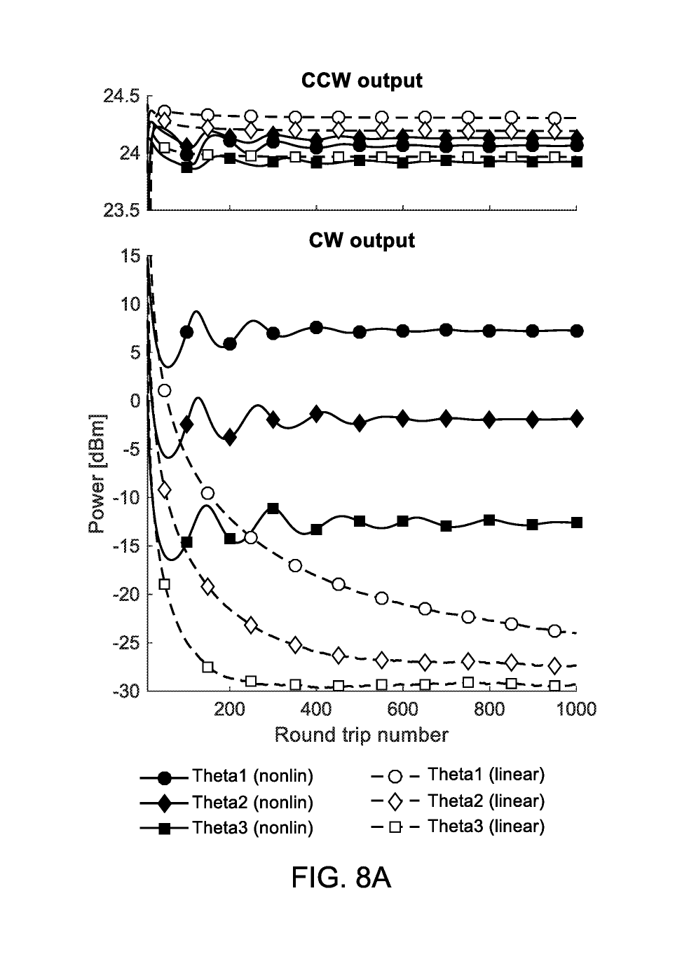

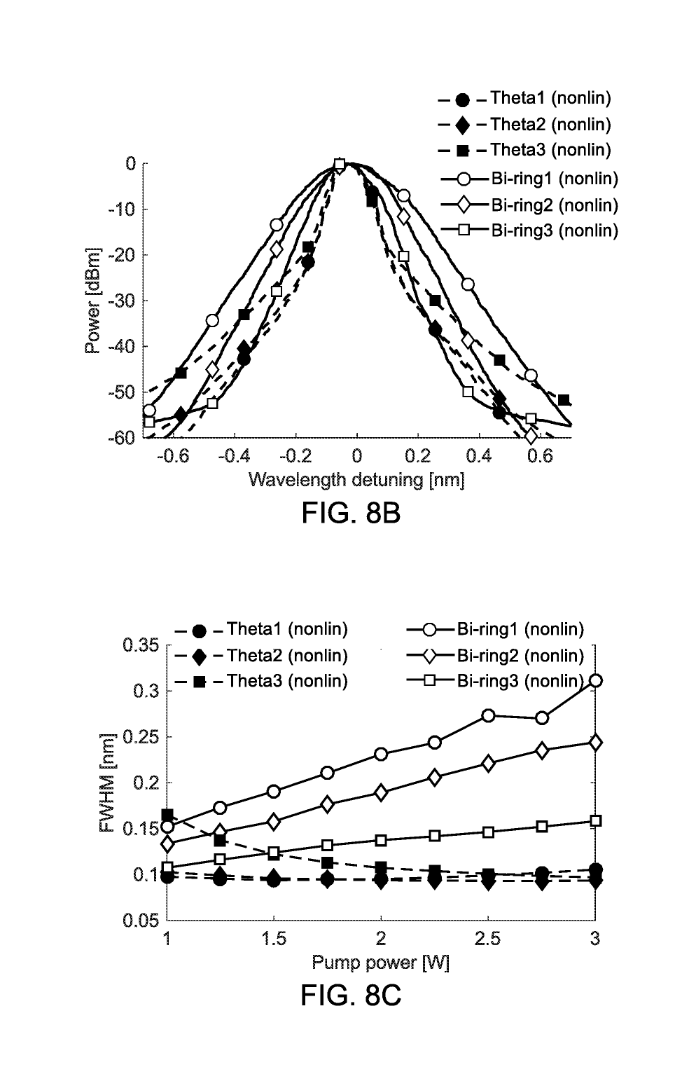

A summary of the simulation results is presented in FIGS. 8A to 8C.

FIGS. 8A to 8C contains simulated characteristics of theta cavity TDF lasers at 2000 nm operating wavelength. The various graphs in FIGS. 8A to 8C comprise:

FIG. 8A shows evolutions of the favoured laser direction (CCW) and suppressed direction (CW) signal power vs. round trips in the linear (dashed lines) and nonlinear (solid lines) cavities. Pump power is 2 W;

FIG. 8B shows spectral line shapes at 2 W of pump power for normal theta (dashed lines) and with a broken S-shape feedback (solid lines) cavities. In the latter case, it operates as a bi-directional ring cavity. The active fiber in both configurations is nonlinear. Spectra are normalized to 0 dBm peak value; and

FIG. 8C shows FWHM of the CCW emitted light vs. pump power in the nonlinear theta cavities: a normal one (dashed lines) and bidirectional ring cavities (solid lines).

The absorption and emission cross-sections, and radiative lifetime of ³H₆→³F₄ Tm³⁺ transition are taken from the reference (fiber Tm1)³⁴. In order to perform the simulations in the reasonable computational time, the doping concentration is set to 3·10²⁵ m⁻³ (comparing to 8.4·10²⁵ m⁻³ reported). It results into the reduced gain in TDF, and therefore leads to the difference between experimentally measured and simulated laser output powers (26 dBm and 24 dBm at 2000 nm for 2 W of pump, respectively).

The first significant discrepancy between the analytical description and experiments is the finite ER between favored and suppressed direction. In FIG. 8A, the favored (CCW) and suppressed (CW) output powers are plotted as a function of cavity round trip for the three theta cavity configurations. The results for a linear TDF (solid line) and nonlinear TDF (dashed line) are compared. The simulation results in the linear case are in good agreement with the analytical description: A the power of the CW signal diminishes with every round trip (note that an apparent saturation around −30 dBm is caused by the numerical limitations of the model) and B Theta1 configuration takes longer to settle into steady-state due to the low value of feedback. When the nonlinearities are taken into account, a behavior similar to the experimentally observed one is depicted: the CW power does not vanish in the steady-state. Some oscillations occur until a finite value is reached. The simulations predict ERs of 16.9 dB, 26.0 dB and 36.5 dB for Theta1, Theta2 and Theta3, respectively. Qualitatively, they are in good agreement with the experiment: higher feedback provides better ER. The quantitative difference between simulated and experimental values can be attributed to the parameter discrepancies between real and modeled TDF (primarily, the doping concentration).

The other unexpected trend lays in the emitted light linewidth. The simulations results for linewidth as a function of pump power are shown in FIG. 8C. When nonlinearities are included in the model, the linewidth of the lasing light follows the experimental behavior: the FWHM remains virtually constant or even reduces with increasing pump power. This can be explained by the impact of the nonlinear amplifying mirror (NALM) existing in the cavity.³⁵ A NALM is indeed included into the laser configuration, starting at the coupler DC₂ and including the TDF and DC₁. The redirected CW signal and the CCW light in the main ring acquire different nonlinear phase shifts while propagating in TDF, and interfere at DC₂, resulting in the linewidth narrowing. The reverse trend (i.e. increasing linewidth with pump power) when the S-shaped feedback is broken speaks in favor of this assumption. In latter case, the laser configuration simply represents bi-directional nonlinear ring cavity, where the emitted signal acquires additional SPM, leading to the spectral broadening of the laser line. Moreover, similar behavior was experimentally observed in the conventional unidirectional ring cavity, where the FWHM is increased from 0.2 nm at 0.6 W of pump power, up to 0.48 nm at 3 W, respectively (FIG. 7C). Additionally, as the NALM can act as an artificial saturable absorber, it could be possible to change the operating regime of the laser from continuous-wave to the pulsed one by enhancing the nonlinear effects in the cavity with sections of highly nonlinear fibers (HNLF) or additional TDF pieces

Theta Cavity with FBG

Similar tests (wavelength tunability, output power and laser linewidth vs. pump power etc.) were performed on the theta cavity with FBG as a wavelength-selective element.

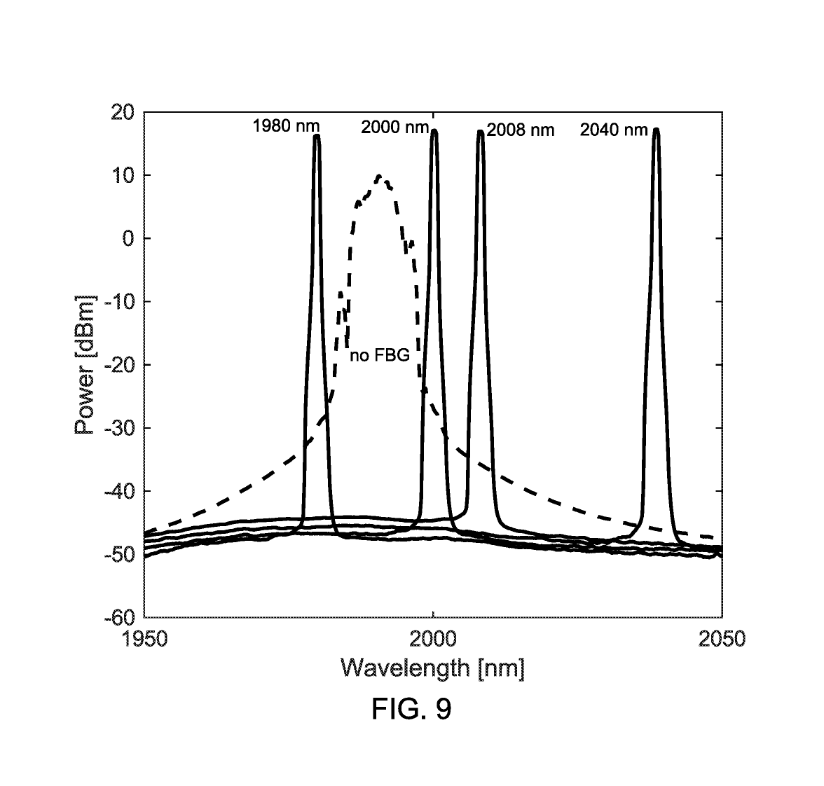

FIG. 9 shows attenuated emission spectra for different FBGs, with a pump power of 3 W and a 1 nm resolution.

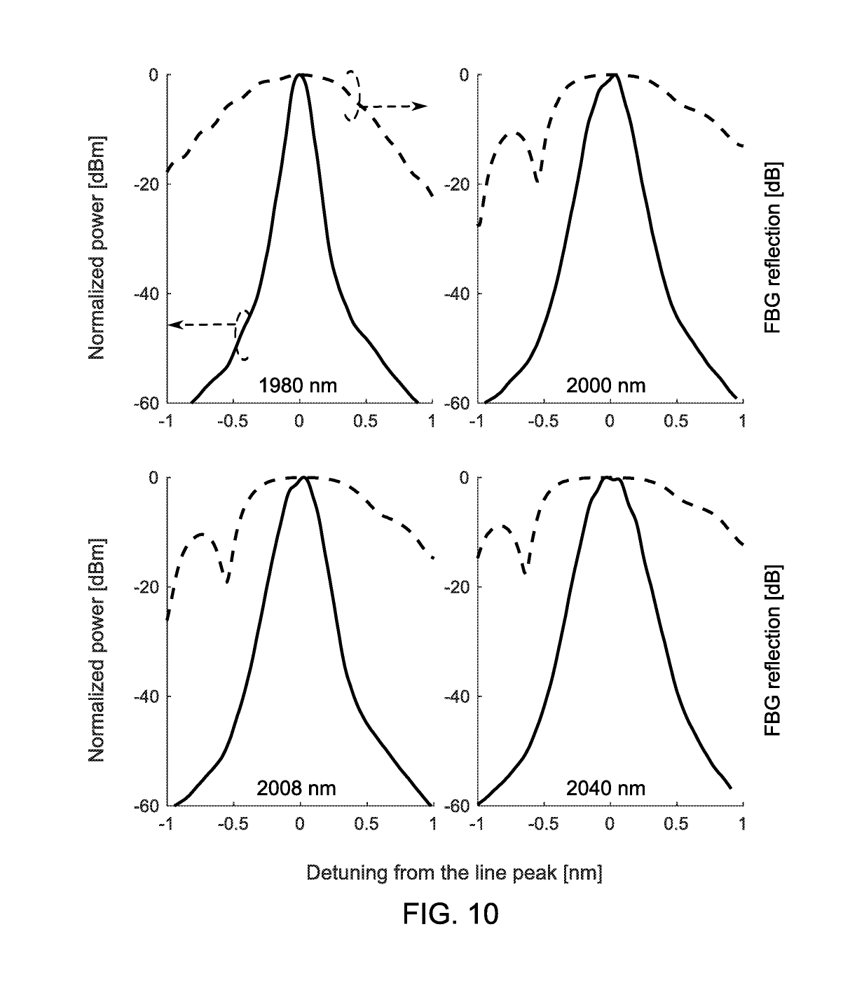

Without a FBG, the cavity lasers around the emission peak at 1990 nm, maintaining, however, unidirectional operation with 22 dB ER (FIG. 9). Once a FBG is inserted, the TDFL generates a narrowband signal, tunable within entire emission bandwidth (FIG. 9—low resolution, FIG. 10—high resolution).

FIG. 10 illustrates laser spectral line shapes for different FBGs, installed in the theta cavity. The pump power is 3 W, and the resolution is 0.05 nm. Dahed lines—normalized reflection functions of FBGs.

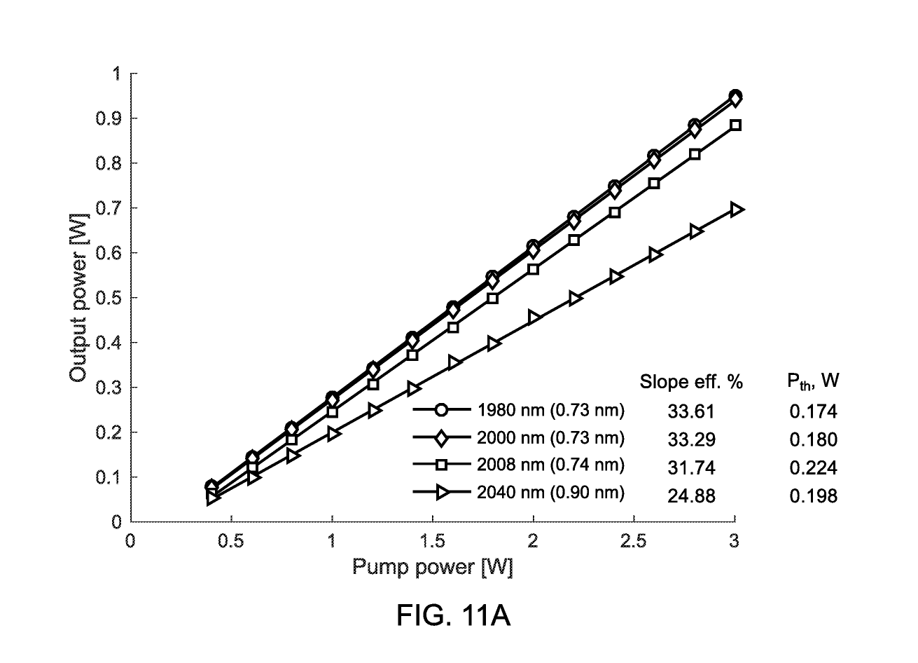

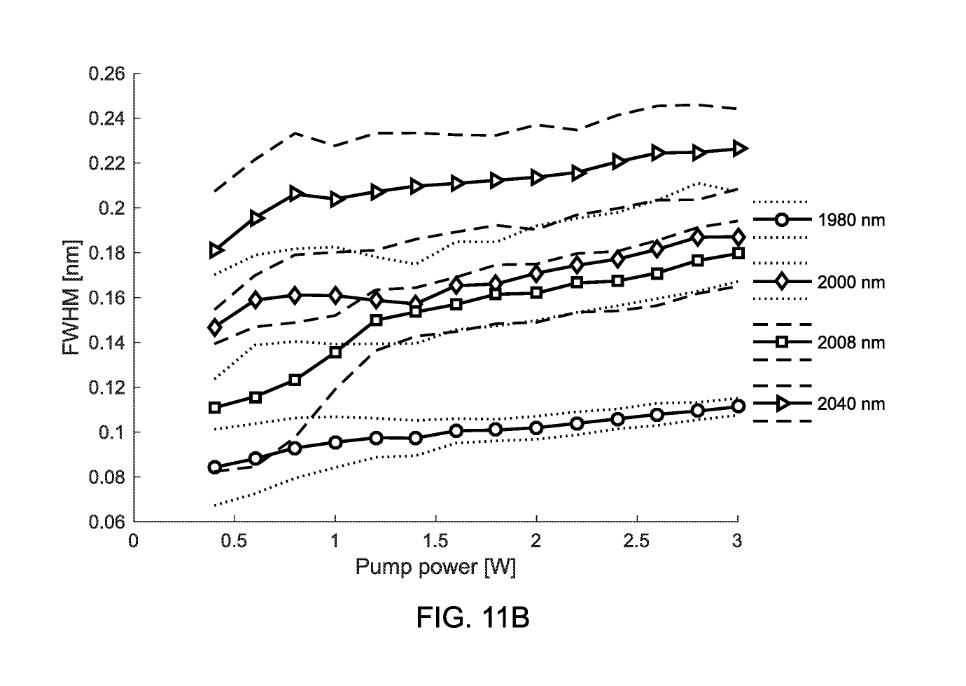

FIGS. 11A and 11B illustrates in two graphs laser performance characteristics; In FIG. 11, the different parts FIGS. 11A and 11B illustrate the following:

FIG. 11A shows the output power of the laser vs. pump power. The inset table shows slope efficiency and pump lasing threshold; and

FIG. 11B shows laser linewidth (FWHM) of the laser vs. pump power. Shadowed regions indicate standard deviation of FWHM (linewidth jitter Δσ_{λ}).

As shown in FIG. 11A, all TDFLs can reach sub-Watt output power level with slope efficiencies of 25-34% and about 0.2 W threshold pump power. Overall, the laser performance of theta TDFL with FBGs is improved, comparing to previously reported theta cavity, which exploited a grating-based filter with 4 dB insertion losses. So, the slope efficiency at 2000 nm is increased from 25% (BPF) to 33% (FBG). A minimal slope efficiency of 24.9% is observed at 2040 nm due to operation at the edge of TDF gain spectrum. The linewidth at 3 W pump ranges from 0.1 nm FWHM at 1980 nm to 0.22 nm FWHM at 2040 nm, with a slope of 0.008 nm/W for 1980 FBG and 0.013 nm/W for other FBGs (FIG. 11B). The FWHM is determined as 2\sqrt{2 ln 2}σ_{λ}, where σ_{λ} is the standard deviation of the spectral line profiles in the wavelength domain. Possible fluctuations of FWHM (linewidth jitter Δσ_{λ}) are shown in FIG. 11B as well. Remarkable point is that theta cavity TDFL, operating at 1980 nm, demonstrates a well-stabilized linewidth (Δσ_{λ} 4 μm at 0.1 nm FWHM). This behavior might be partially attributed to the operation close to the TDF gain peak. However, we believe that the chirping of the FBG strongly contributes to low linewidth jitter, because 2000 nm laser, exploiting regular FBG and emitting in the vicinity of maximum gain as well, exhibits much higher FWHM deviations (20 μm).

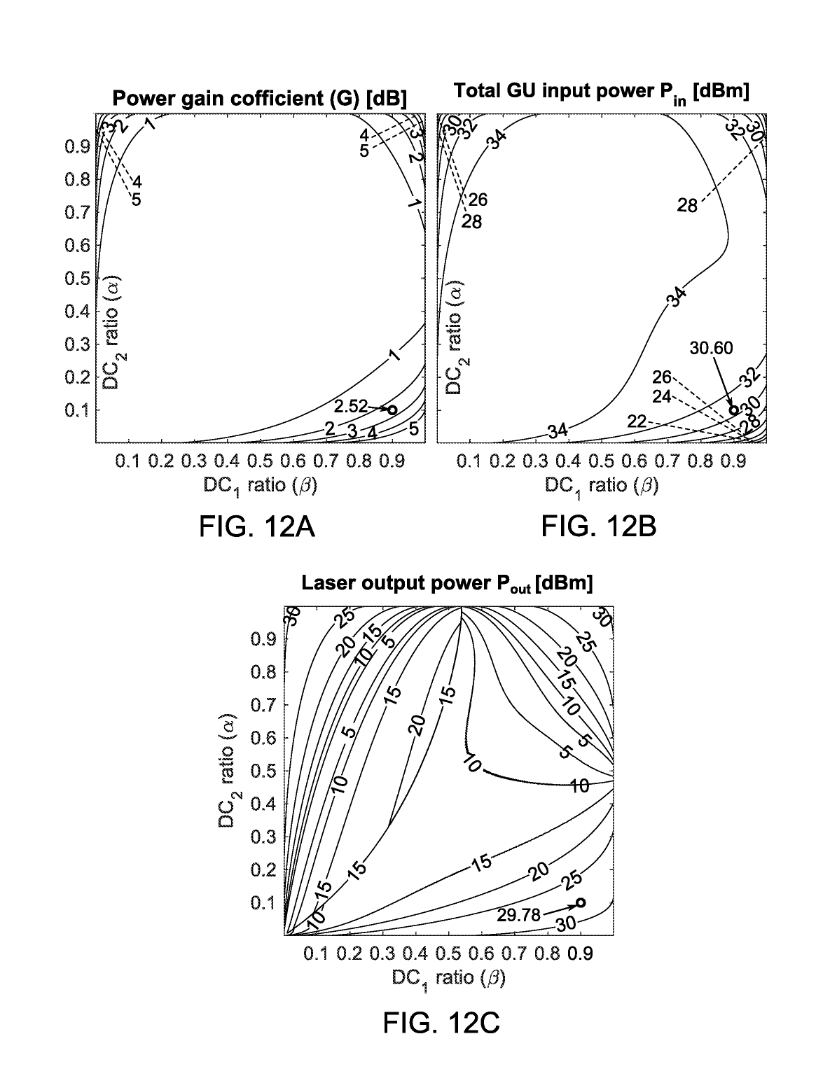

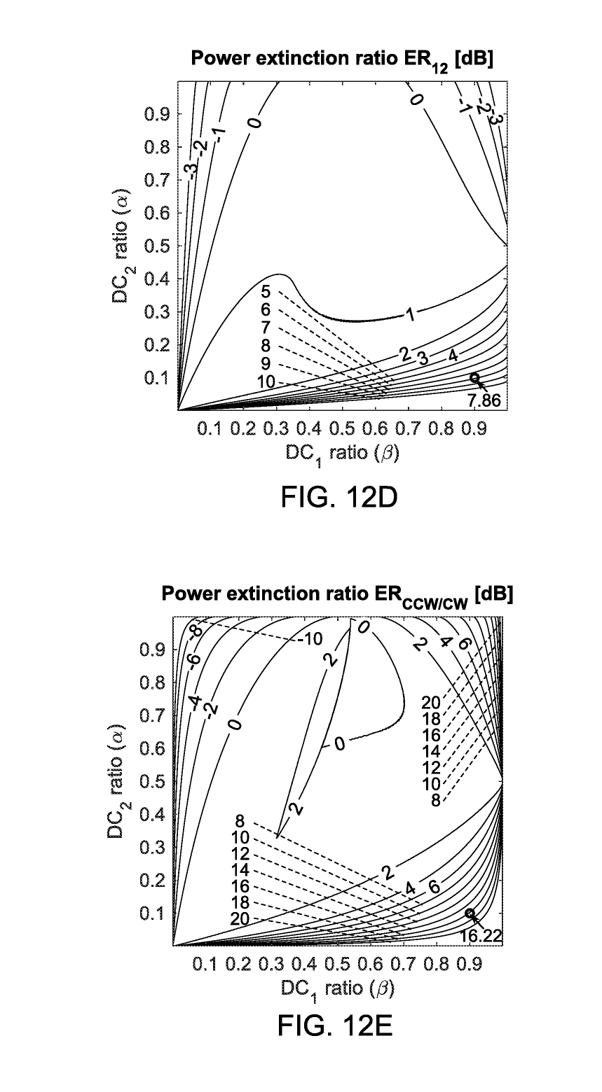

FIGS. 12A to 12E shows a series of contour plots illustrating theoretical performance characteristics of the theta laser for various combination of the DC1 and DC2 coupling ratios. In FIGS. 12A to 12E, the various parts are explained in the following as corresponding to:

FIG. 12A shows power gain coefficient G=20 log₁₀|g₀|;

FIG. 12B shows total intra-cavity input power, entering GU;

FIG. 12C shows the laser output power.

FIG. 12D shows power extinction ratio of directional modes, evaluated at the inputs of the GU,

$${η}_{12} = 20 {log}_{10} \vert \frac{{E}_{1}}{{E}_{2}} \vert ;$$

and

FIG. 12E shows power extinction ratio, of directional modes, evaluated at the monitoring point M

$${η}_{CCW / CW} = 20 {log}_{10} \vert \frac{{E}_{CCW}}{{E}_{CW}} \vert .$$

Current coupling ratio combination (0.9, 0.1) is marked with circles on the corresponding plots and corresponding values.

To illustrate that the choice of DC₁ and DC₂ coupling ratios strongly affects the performance of the laser, the theoretical evaluation of laser characteristics (power gain coefficient, intra-cavity power, extinction ratio, and output power, Eq. (1.12)) have been performed for the theta cavity with previously described GU, FBG at 2000 nm, with 0.2 nm bandwidth and 90% power reflection coefficient (r=\sqrt{0.9}). From results, presented in FIG. 12, one can conclude that the current coupling ratio combination (0.9, 0.1) should provide a high output power of 1 W (29.78 dBm) (FIG. 12C), with 7.9 dB power ER) (FIG. 12D). It should be taken into account that experimentally evaluated power extinction ratio η_{CCW/CW} can be easily measured with a single monitoring coupler DC₃, while two extra couplers are required to measure directly input powers of the directional modes, and to evaluate the native power extinction ratio η₁₂. So, η_{CCW/CW}(0.9,0.1)=16.2 dB) (FIG. 12E), which is in a good agreement with experimentally observed values of 21 dB. Unlike for the theta cavity with BPF, the steady-state gain coefficient of the theta laser with FBG in the most cases is much lower than the total loss in the main ring Lₜₒₜₐₗ=\sqrt{1−β}\sqrt{1−α}. For instance, in our current configuration the Lₜₒₜₐₗ=10.45 dB, while G=2.52 dB (FIG. 12A), which results in a higher output power, and better OSNR. However, a performance of any theta cavity layout with FBG should be preliminary estimated using the theoretical model (Eq. (1.12), because there are certain combinations of the cavity parameters (FBG reflectivity, and DC₁ and DC₂ coupling ratios), which can lead to the extremely low output power values (where virtually all of the laser power circulates in the cavity with a low out-coupling, see 5 dBm contour lines in FIG. 12 C).

As the theta laser with FBG consists of two superimposed resonators, the last important aspect to be discussed, is an influence of phase delays in cavity arms ψ_{1,2,3} on the spectral properties of the output signal, and, particularly on the gain envelope profile g(λ). So, we return to a full solution for the gain coefficient (Eq. (1.12)). As it can be seen, the length of the GU arm does not change the shape of g(λ)-function, but the difference ξ=θ+ψ₃−ψ₂ should have some impact. To investigate it, the time delays τ₁=100 ns, τ₂=10 ns, and τ₃=9.25 10 ns, were assigned to the existing theta cavity with (0.9,0.1) coupler split ratio, the gain profiles were calculated, and superimposed with spectral lineshapes S(λ) that were retrieved from VPI schematics. Note that the optical fiber of 1 m length, having a phase index of n₀=1.45, provides a time delay of 4.8 ns, so we simulate a realistic scenario, where cavity arms have length of about 20 m (GU arm), 2 m, and 1.8-2 m (S-shape feedback arm).

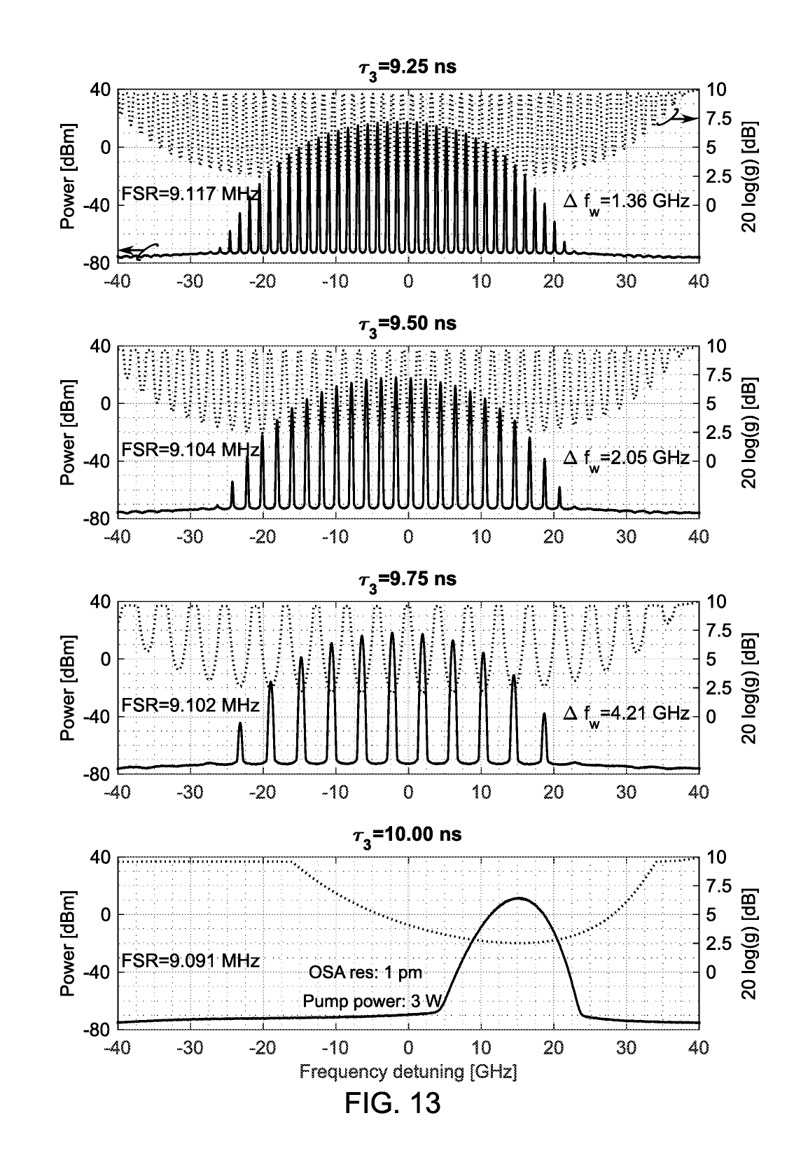

The results are shown in FIG. 13. For the time delay τ₃=τ₂=10 ns, ξ=θ, the gain profile g(λ) is identical to the one calculated using a simplified expression (1.13). For a non-zero difference ψ₃−ψ₂=ω(τ₃−τ₂), the gain profile consists of certain spectral windows with a spacing Δf w: |τ₃−τ₂|⁻¹. So, for example, for τ₂=10 ns and τ₃=9.75 ns, such windows are separated by approximately 4.2 GHz. So, there is a possibility for a spectral shaping of the gain profile by tuning the relative phase delay between arms. It is worth mentioning that the free spectral range (FSR) of the cavity is in all simulated cases of about 9.1 MHz, so there are tens of longitudinal modes within each gain window. The minimal gain coefficient g(λ′) for the non-zero difference ψ₃−ψ₂ is about 2 dB, which is a bit smaller than g=2.5 dB for the case of perfectly balanced arms ψ₃−ψ₂=0. However, other laser characteristics, namely output power Pₒᵤₜ^{laser}=28.5 dBm, and extinction ratio η_{CCW/CW}=16.4 dB, are kept invariant for any value of the relative phase delay.

FIG. 13 shows theoretical gain coefficient spectra g(λ) and modeled spectral lineshapes S(λ) of the FBG theta laser with (0.9,0.1) coupler split ratio that takes into account phase delays in cavity arms (Eq. (1.12)). The FSR indicates longitudinal modes spacing, Δf_{w}—distance between gain windows.

Lasers with a Double Gain Unit

Dual-Band Theta Laser with Fiber Bragg Gratings and Thulium- and Holmium-Doped Fibers

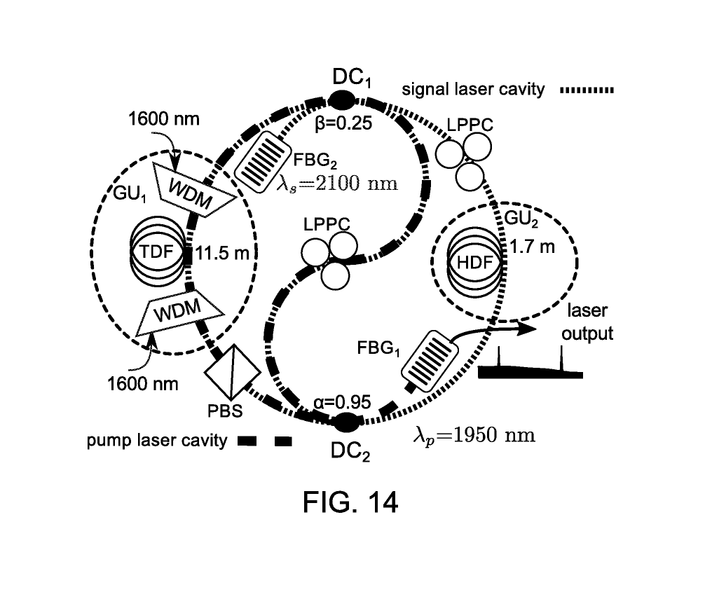

In the section above we have described an experimental demonstration of all-fiber theta laser with one FBG as a spectrally-selective element. As the next step, the cavity functionality can be enhanced toward dual-emission band operation, by adding another FBG to the last unused port of the directional couplers, and, if necessary, the second gain unit to the main ring. In this case, an emission of the first gain unit (GU₁) can be completely, or partially guided as a pump to the second active fiber (GU₂), as shown FIG. 14.

FIG. 14 shows dual-emission bands theta laser with thulium- and holmium-doped fibers. HDF: holmium-doped fiber.

In the presented configuration, GU₁ is our main gain unit (FIG. 3). FBG₁ is chosen to select 1950 nm wavelength. GU₂ consists of 1.7 m of holmium-doped fiber (HDF) core pumped with 1950 nm emission of GU₁. We have exploited the feature that emission cross-section of Tm³⁺-ions considerably overlaps with absorption cross-section of Ho³⁺-ions.

FBG₂ is centered at 2100 nm. So, GU₁ functions in the Sagnac loop cavity, acting as a pump source for GU₂, which operates in the theta cavity. By adjusting the FBGs reflectivity, and DC_{1,2} coupling ratio, we can obtain either single-wavelength emission at 2100 nm, or dual-wavelength lasing at both 2100 nm, and 1950 nm. The polarization beam splitter (PBS) and large paddle polarization controllers (LPPC) are optionally included in the cavity. DC₁ and DC₂ have cross-coupling ratios of 25% and 90%, respectively. The power reflection coefficient of the grating, used as FBG₁, is 99% and 13.5% for the single- and dual-wavelength operation, respectively. The FBG₁ has 0.2 nm FWHM bandwidth and 95% peak reflection. The transmission port of FBG₁ is used as a laser output in both configurations.

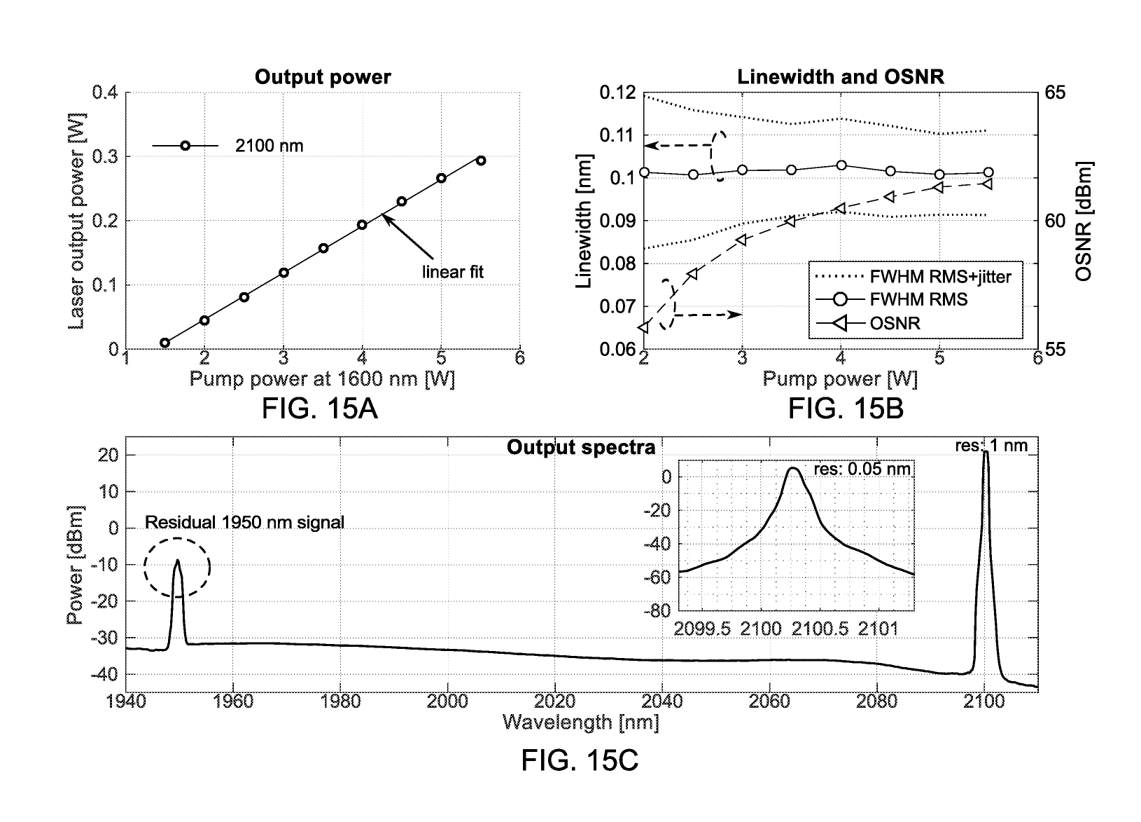

FIGS. 15A to 15C show single-wavelength laser performance characteristics. FIG. 15A shows Output vs. pump power, FIG. 15B shows laser linewidth (FWHM) and OSNR vs. pump power. Possible fluctuations of FWHM (linewidth jitter Δσ_{λ}) are shown as well (dotted lines area), and FIG. 15C shows output laser spectra, recorded at low and high (insets) resolution for various levels of the pump power.

First, the single-wavelength operation at 2100 nm was investigated, and the results are summarized in FIGS. 15A to 15C. The laser provides up to 300 mW output power with 8% slope efficiency, threshold power of 1.4 W, and OSNR better than 55 dBm/1 nm. Remarkably, the laser linewidth (FWHM) is virtually constant at 0.1 nm, and very stable versus increasing pump power, which is indicated by lowering the wavelength jitter (FIG. 15B-C). It should be noted that despite of a high reflection (HR) of FBG₁ (99%), there is a very small residual 1950 nm signal in output spectra (FIG. 15C). A spectral instability of the 1950 nm signal is caused by 1.5 nm broad reflection bandwidth of HR grating.

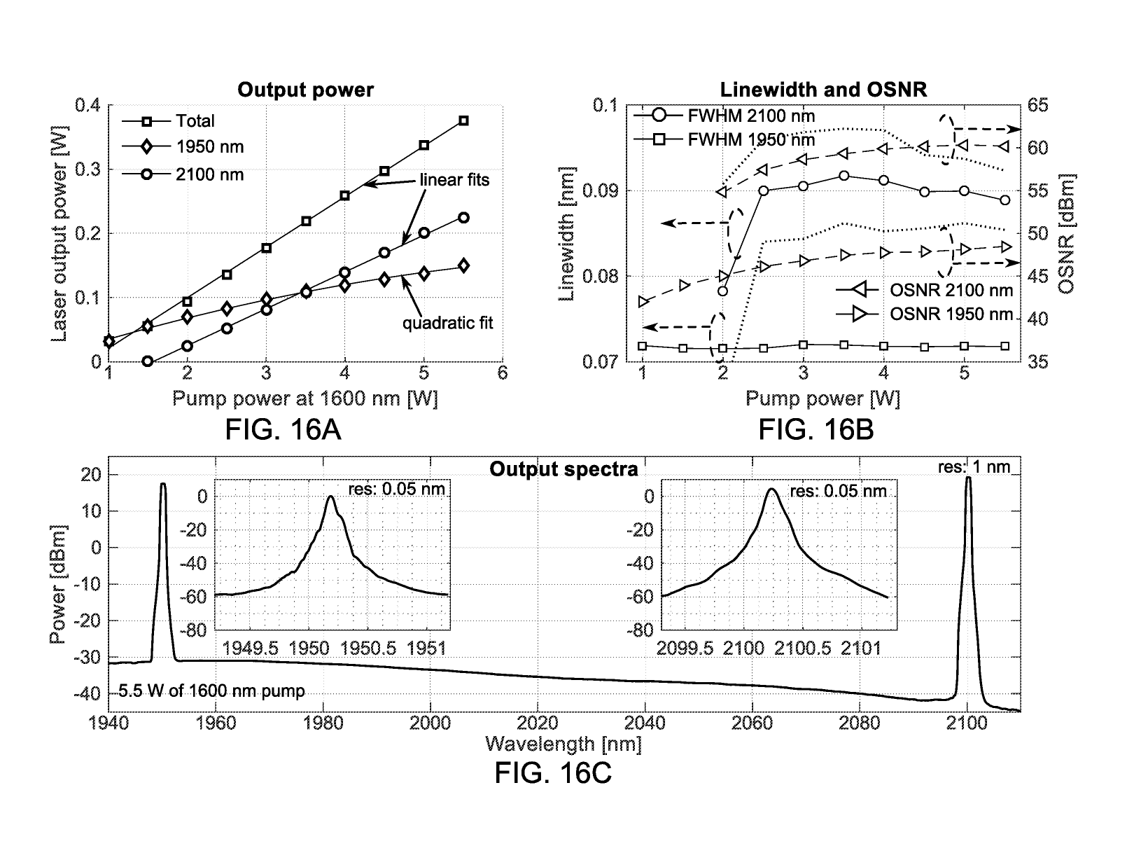

FIGS. 16A to 16C shows Dual-wavelength laser performance characteristics, with FIG. 16A showing output vs. pump power, FIG. 16B showing laser linewidth (FWHM) and OSNR vs. pump power, where the dotted lines area depicts the linewidth jitter Δσ_{λ} of 2100 nm laser, and FIG. 16C showing output laser spectra, recorded at low and high (insets) resolution for various levels of the pump power.

Furthermore, changing the FBG₁ to the low-reflection (LR) grating with 0.1 nm FWHM bandwidth and 13.5% peak reflection, we obtain a dual-band fiber laser operation, where 1950 nm emission from GU₁ is partly coupled out, and partly forwarded as a pump for the holmium-doped fiber in GU₂. The laser performance characteristics are shown in FIG. 16. As the FBG₁ reflectivity has been reduced, the loss of Sagnac resonator at 1950 nm is increased, resulting in a lower power, coupled to GU₂, and, consequently, in lower power generated at 2100 nm (up to 220 mW with 6% slope efficiency, and 1.5 W threshold power), while the OSNR remain higher than 55 dB/1 nm. The 1950 nm signal evolves nonlinearly with increasing 1600 nm power, reaching a maximum value of 150 mW (FIG. 16A). A lower OSNR of 1950-nm signal comparing to 2100-nm one (42-50 dB/1 nm) originates from considerably higher Sagnac-cavity loss, which GU₁ needs to compensate for. The laser linewidth is stabilized at about 0.07 nm and 0.09 nm FWHM for 1950 nm and 2100 nm signals, respectively (FIG. 16B). However, we should keep in mind that the true linewidth not be correctly estimated, as the finest resolution of available OSA is 0.05 nm.

A high lasing threshold at 2100 nm in both configurations can be attributed to relatively high cavity loss, introduced by some components (PBS, LPPC), a redundant length of TDF (11.5 m), and bending and absorption loss in passive fibers. So, performance of 2100 nm laser can be significantly improved by an optimization of the resonator. The bending losses can be reduced after replacement of passive components made with SMF-28 fiber, by ones based on SM2000 fiber. An overall shortening of cavity length will reduce an absorption in a fused silica (0.1 dB/m at 2100 nm).

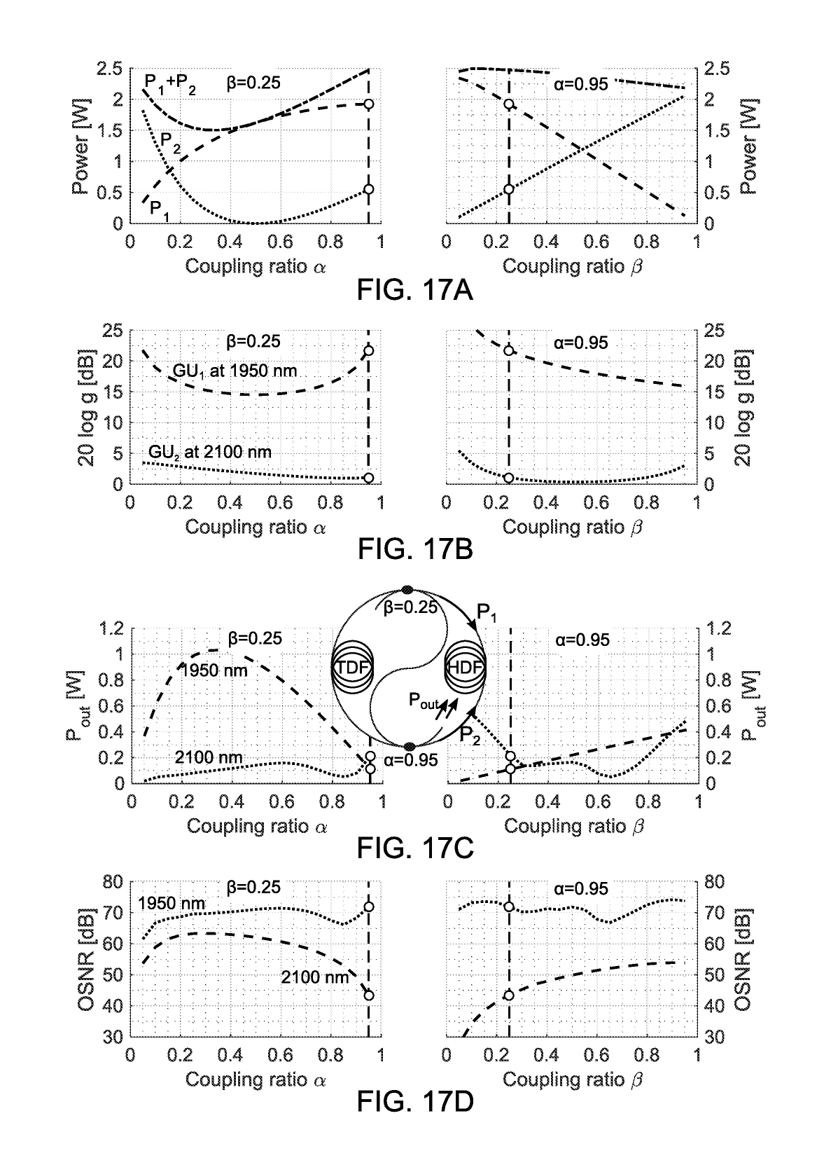

FIGS. 17A to 17D shows dual-band theta laser simulations results: coupling rations α and β are alternately swept, and laser performance characteristics are recorded, with FIG. 17A showing 1950 nm emission, generated in GU₁, and coupled into the HDF through DC_{1,2}, FIG. 17B showing steady-state gain coefficients, provided by GU₁ and GU₂ at 1950 nm and 2100 nm, respectively, FIG. 17C showing laser output power, and FIG. 17D Laser output OSNR. Experimental configuration is labelled with a dashed line. Pump power at 1600 nm is 5.5 W.

The performance characteristics of both Sagnac- and theta laser are strongly affected by power split ratios of the intracavity couplers. In order to investigate an optimization potential of the dual-band theta laser, the corresponding model was implemented in VPI. To decrease a total simulation time, and amount of generated data, coupling ratios α and β were not simultaneously, but alternately swept: we fix the split ratio of one coupler, and change it for another one. The total power at 1600 nm, coupled from both sides to GU₁ is 5.5 W. The summary of results is presented in FIGS. 17A to 17D.

First, 1950 nm pump, coupled from both sides to the HDF, was evaluated. About 2 W of pump power is always coupled to the GU₂, and experimentally we operate in the vicinity of the extremum point. Also, at the P₂(α) curve (FIG. 17A) a signature of the Sagnac-cavity operation is present: at 50%/50% split ratio, the P₂=0 due to the perfect destructive interference. However, there is always a non-zero 1950 nm pump P₁, coupled through coupler DC₁.

It should be noted that due to the operation in the theta resonator, GU₂ is required to provide significantly lower steady-state gain, comparing to the GU₁ in the Sagnac-cavity. Particularly, for our initial configuration (0.25,0.95) the modeled gain is 20 log₁₀g₁=21.75 dB at 1950 nm in GU₁ and 20 log₁₀g₂=1.25 dB at 2100 nm in GU₂. The real gain g₂, established in the experiment, might be 1-2 dB higher, as bending loss and absorption in the passive fibers are not included in the model, however, the difference

$$20 {log}_{10} \frac{{g}_{2}}{{g}_{1}}$$

of more than 10 dB for all of the configurations is ensured (FIG. 17B). High values of g₁ is also the reason for degraded OSNR at 1950 nm, comparing to 2100 nm signal (FIG. 17D).

The output powers at both wavelengths can be greatly manipulated by changing α and β parameters, to favour either of the signals or to equalize them. So, for example, change of ratio β from 0.25 to 0.1 or 0.9 should increase a power of 2100 nm signal from 210 mW to about 500 mW (FIG. 17C). This behaviour conforms to the theoretical model of the theta cavity: to yield a high power, one has to operate around (0.1,0.9), (0.9,0.1), (0.9,0.9)-points in (β,α)-space.

Potential Improvements

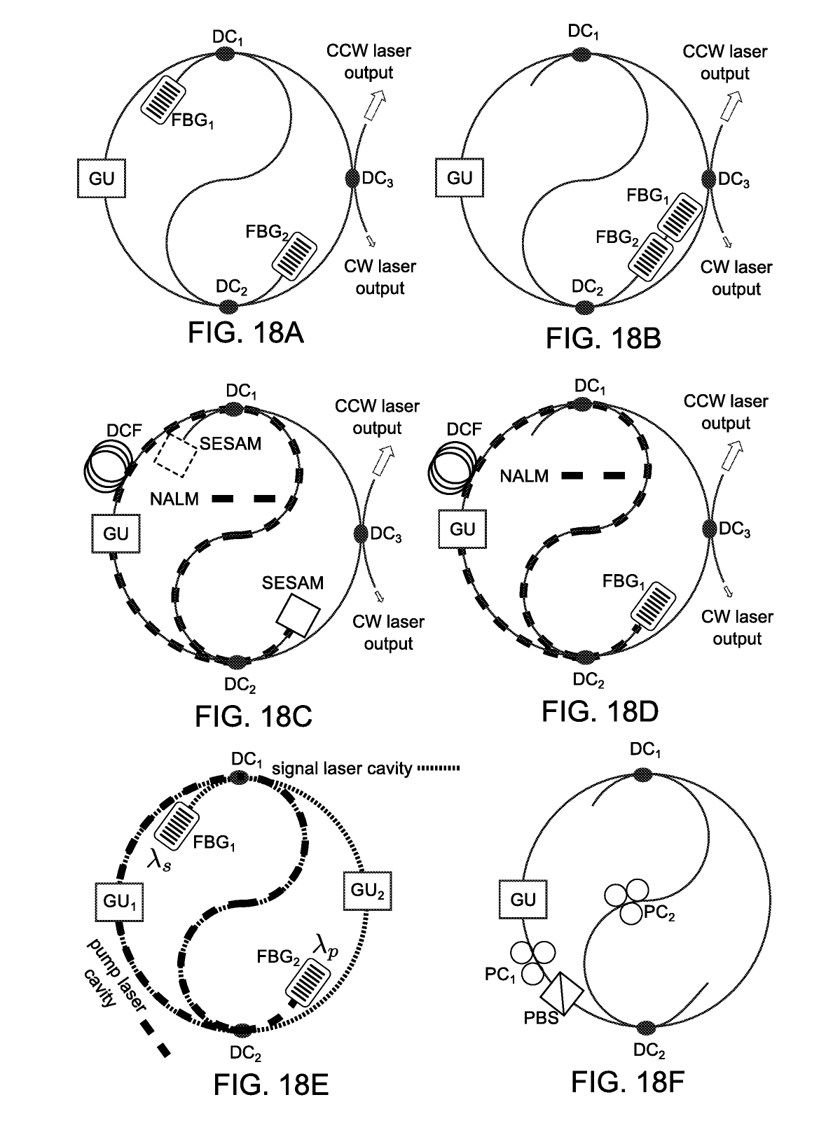

FIGS. 18A to 18F show a number of theta cavity lasers according to preferred embodiments of the invention. The theta cavity laser illustrated in FIGS. 18A to 18F represent preferred embodiments, and are describes herein below:

FIGS. 18A-18B contain a dual wavelength laser using two independent FBGs, attached either to both free outputs of couplers DC₁ and DC₂, or to one of the ports;

FIGS. 18C-18D show pulsed operations of the fiber laser, initiated mode-locked with saturable absorber semiconductor mirror (SESAM), connected to one of the free ports and (or) exploiting nonlinear effects inside of the cavity (intensity-dependent transmission of nonlinear amplifying loop mirror (NALM) and nonlinear polarization rotation (NPR);

FIG. 18D represents a case, in which there is no SESAM installed. The FBG can be used to seed the pulsed operation around the specific wavelength. A passive dispersion compensating fiber (DCF) should be used to compensate for anomalous group velocity dispersion in 2000 nm band;

FIG. 18E shows two different gain units that may be incorporated in a same cavity, providing the laser emission in two distinct bands. One gain unit (GU₁) will operate at the wavelength λₚ in a Sagnac cavity, and will be a pump for another gain unit (GU₂), lasing at the wavelength λₛ in a normal theta cavity. The lasing wavelengths λₚ and λₛ are determined by FBG₂ and FBG₁, respectively. For example, GU₁ can be built with thulium-doped fiber, and λₚ=1950 nm, while GU₂ is based on holmium-doped fiber with Δₛ=2000-2150 nm; and

FIG. 18F shows how polarization controllers may be included in the main loop (PC1) and in the feedback (PC2), to align the polarization states of the CCW and CW propagating fields. Otherwise the entire cavity may be implemented using polarization maintaining fibers (PMF). If a polarized emission is required, a polarization beam splitter (PBS) could be also included in the main ring.

### REFERENCES

1. Godard, A. Infrared (2-12 μm) solid-state laser sources: a review. Comptes Rendus Phys. 8, 1100-1128 (2007).
2. Koch, G. J. et al. High-energy 2 μm Doppler lidar for wind measurements. Opt. Eng. 46, 116201-116214 (2007).
3. De Young, R. J. & Barnes, N. P. Profiling atmospheric water vapor using a fiber laser lidar system. Appl. Opt. 49, 562-567 (2010).
4. Ishii, S. et al. Coherent 2 μm differential absorption and wind lidar with conductively cooled laser and two-axis scanning device. Appl. Opt. 49, 1809-1817 (2010).
5. Jackson, S. D. Towards high-power mid-infrared emission from a fiber laser. Nat. Photonics 6, 423-431 (2012).
6. Sprangle, P., Ting, A., Penano, J., Fischer, R. & Hafizi, B. Incoherent Combining and Atmospheric Propagation of High-Power Fiber Lasers for Directed-Energy Applications. Quantum Electron. IEEE J. 45, 138-148 (2009).
7. Hanson, F., Poirier, P., Haddock, D., Kichura, D. & Lasher, M. Laser propagation at 1.56 μm and 3.60 μm in maritime environments. Appl. Opt. 48, 4149-4157 (2009).
8. Petrovich, M. N. et al. Demonstration of amplified data transmission at 2 μm in a low-loss wide bandwidth hollow core photonic bandgap fiber. Opt. Express 21, 28559-28569 (2013).
9. Li, Z. et al. Thulium-doped fiber amplifier for optical communications at 2 μm. Opt. Express 21, 9289-9297 (2013).
10. Simakov, N., Hemming, A., Clarkson, W. A., Haub, J. & Carter, A. A cladding-pumped, tunable holmium doped fiber laser. Opt. Express 21, 28415-22 (2013).
11. Swiderski, J. & Michalska, M. High-power supercontinuum generation in a ZBLAN fiber with very efficient power distribution toward the mid-infrared. Opt. Lett. 39, 910-913 (2014).
12. Yang, W., Zhang, B., Xue, G., Yin, K. & Hou, J. Thirteen watt all-fiber mid-infrared supercontinuum generation in a single mode ZBLAN fiber pumped by a 2 μm MOPA system. Opt. Lett. 39, 1849-1852 (2014).
13. Li, Z., Alam, S. U., Jung, Y., Heidt, A. M. & Richardson, D. J. All-fiber, ultra-wideband tunable laser at 2 μm. Opt. Lett. 38, 4739-42 (2013).
14. Yin, K., Zhang, B., Xue, G., Li, L. & Hou, J. High-power all-fiber wavelength-tunable thulium doped fiber laser at 2 μm. Opt. Express 22, 19947-19952 (2014).
15. Geng, J., Wang, Q., Wang, J., Jiang, S. & Hsu, K. All-fiber wavelength-swept laser near 2 μm. Opt. Lett. 36, 3771-3 (2011).
16. Billat, A., Cordette, S., Tseng, Y.-P., Kharitonov, S. & Brès, C.-S. High-power parametric conversion from near-infrared to short-wave infrared. Opt. Express 22, 14341-7 (2014).
17. Jalas, D. et al. What is—and what is not—an optical isolator. Nat. Photonics 7, 579-582 (2013).
18. Lee, S., Mandridis, D. & Delfyett, P. J. eXtreme Chirped Pulse Oscillator Operating in the Nanosecond Stretched Pulse Regime. Opt. Express 16, 4766-4773 (2008).
19. Ja, Y. H. Densely spaced two-channel wavelength division demultiplexer with an S-shaped two-coupler optical fiber ring resonator. Appl. Opt. 32, 6679-83 (1993).
20. Ja, Y. H. Simultaneous resonance of an S-shaped two-coupler optical fiber ring resonator. Opt. Commun. 102, 133-140 (1993).
21. Ja, Y. H. Butterworth-like filters using a S-shaped two-coupler optical fiber ring resonator. Microw. Opt. Technol. Lett. 6, 376-378 (1993).
22. Shi, Y., Sejka, M. & Poulsen, O. Unidirectional Er3+-doped fiber ring laser without isolator. IEEE Photonics Technol. Lett. 7, 290-292 (1995).
23. Hohimer, J. P. & Vawter, G. A. Unidirectional semiconductor ring lasers with racetrack cavities. Appl. Phys. Lett. 63, 2457 (1993).
24. Cao, H. et al. Highly unidirectional InAs/InGaAs/GaAs quantum-dot ring lasers. Appl. Phys. Lett. 86, (2005).
25. Nshii, C. C. et al. A unidirectional quantum cascade ring laser. Appl. Phys. Lett. 97, 231107 (2010).
26. Chernysheva, M. et al. High Power Q-Switched Thulium Doped Fiber Laser using Carbon Nanotube Polymer Composite Saturable Absorber. Sci. Rep. 6, 24220 (2016).
27. Langlois, S. & Lit, J. W. Y. S-resonator with an end reflector. J. Light. Technol. 17, 1487-1492 (1999).
28. Wei, L. & Lit, J. W. Y. Compound ring resonator with an external reflector for lasers. Optics Communications 193, (2001).
29. Xia, J. et al. Self-seeded multiwavelength Brillouin-erbium laser using NOLM-NALM. Laser Phys. 18, 442-445 (2008).
30. Peterka, P., Faure, B., Blanc, W., Karásek, M. & Dussardier, B. Theoretical modelling of S-band thulium-doped silica fiber amplifiers. Opt. Quantum Electron. 36, 201-212 (2004).
31. Peterka, P., Kasik, I., Dhar, A., Dussardier, B. & Blanc, W. Theoretical modeling of fiber laser at 810 nm based on thulium-doped silica fibers with enhanced 3H4 level lifetime. Opt. Express 19, 2773-81 (2011).
32. Komukai, T., Yamamoto, T., Sugawa, T. & Miyajima, Y. Upconversion pumped thulium-doped fluoride fiber amplifier and laser operating at 1.47 μm. IEEE J Quantum Electron. 31, 1880-1889 (1995).
33. Kożak, M. M. Development of Thulium-Doped Fluoride Fiber Amplifiers. (Cuvillier Verlag, 2006).
34. Agger, S. D. & Povlsen, J. H. Emission and absorption cross section of thulium doped silica fibers. Opt. Express 14, 50 (2006).
35. Fermann, M. E., Haberl, F., Hofer, M. & Hochreiter, H. Nonlinear amplifying loop mirror. Opt. Lett. 15, 752 (1990).

1-11. (canceled)

12: A unidirectional short-wave infrared fiber laser comprising:
a theta cavity with a gain unit based on rare-earth cations-doped fiber, the theta cavity including a ring cavity with two additional 2 input ports×2 output ports directional couplers DC1 and DC2, one port of the directional coupler DC1 being connected to another port of the directional coupler DC2, forming an S-shaped feedback;
a band-pass filter configured to select at a laser wavelength by filtering through transmission inside the theta cavity, the band-pass filter includes at least one of a grating-based filter, a Fabry-Perot etalon, and a phase shifted fiber-Bragg grating; and
a reflective fiber Bragg grating (FBG) configured to select the laser wavelength by filtering through reflection inside the theta cavity,
wherein the fiber Bragg grating (FBG) is a notch filter, and
wherein the fiber Bragg grating (FBG) is attached to an unused port of the directional coupler DC1 or DC2.

13: The fiber laser of claim 12, wherein the rare-earth cation-doped fiber includes at least one of a thulium-doped silica fiber for emission at 1700-2100 nm, a holmium-doped silica fiber for emission at 2000-2150 nm, thulium-holmium-co-doped silica fibers for emission at 1800-2150 nm, a thulium-doped fluoride fiber for emission at 2200-2500 nm, a holmium-doped fluoride fiber for emission around 3000 nm, and an erbium-doped fluoride fiber for emission around 2800 nm and 3500 nm.

14: The fiber laser of claim 12, wherein the theta cavity with fiber Bragg grating is a truly all-fiber configuration without packaged free-space elements.

15: The fiber laser of claim 12, wherein the rare-earth cation-doped fiber is configured to exhibit the Kerr-nonlinearity coefficient higher than corresponding nonlinear coefficients of a passive fibers in the cavity and to include a nonlinear amplifying loop mirror (NALM), including a cation-doped fiber, and the S-shaped feedback.

16: The fiber laser of claim 12, further comprising:
a solid-state saturable absorber (SESAM) attached to one of the unused ports of the couplers DC1 or DC2, to achieve a pulsed operation of the theta cavity.

17: The fiber laser of claim 12, further comprising:
an optimized nonlinear amplifying loop mirror (NALM) acting as an artificial saturable absorber, to achieve a pulsed operation of the theta cavity.

18: The fiber laser of claim 16, further comprising:
a section of dispersion compensating fiber to reduce a duration of generated pulses of the pulsed operation.

19: The fiber laser of claim 17, further comprising:
a section of dispersion compensating fiber to reduce a duration of generated pulses of the pulsed operation.

20: The fiber laser of claim 12, further comprising at least one of a polarization controller, and a polarizer in the cavity, thereby achieving an enhanced functionality.

21: The fiber laser of claim 12, wherein the theta cavity with fiber Bragg grating is configured to operate at two different wavelengths, by two fiber Bragg gratings attached to free ports of directional couplers DC1 and DC2, or fiber Bragg gratings cascaded at one port, to emit at a same laser transition.

22: The fiber laser of claim 12, wherein the theta cavity with fiber Bragg grating is configured to operate at two different wavelengths, comprising two fiber Bragg gratings attached to free ports of directional couplers DC1 and DC2, or fiber Bragg gratings cascaded at one port, emitting at different laser transitions of a single or dual gain units.
